(19) United States
(12) Patent Application Publication
(10) Pub. No.: US 2011/0145073 A1
(43) Pub. Date: Jun. 16, 2011

(54) MULTI-FUNCTION KIOSK SYSTEM

(75) Inventors: BEN RICHMAN, New York, NY (US); Gene Pressman, Rye, NY (US)

(73) Assignee: KEOCONNECT LLC

(21) Appl. No.: 12/970,149

(22) Filed: Dec. 16, 2010

Related U.S. Application Data
(60) Provisional application No. 61/287,111, filed on Dec. 16, 2009.

(51) Int. Cl. G06Q 30/00

(52) U.S. Cl. 705/14.66; 705/14.4; 705/14.73

(57) ABSTRACT

A kiosk includes a first display and a second display. An interactive interface is also included to allow a user to interact with the kiosk and select content for display on the second display. A computing device is operatively coupled to the first display, second display and interactive interface for storing content for display on the first and second displays and for responding to input by the user on the interactive interface. A connection, operatively coupled to the computing device, is provided for interacting with a user's portable device. The first display, second display, interactive interface, computing device, and connection are enclosed and supported in an enclosure. Advertising content is stored on the computing device for display on the first display, and interactive content is stored on the computing device for display on the second display. A network of the kiosks includes a central server and a plurality of the kiosks operatively connected to the central server to provide two-way data flow between the central server and a kiosk and between a kiosk and the central server.

### CROSS REFERENCE TO RELATED APPLICATION

This application claims the benefit of U.S. Provisional Application Ser. No. 61/287,111, filed Dec. 16, 2009.

### BACKGROUND OF THE INVENTION

1. Field of the Invention

The present invention is a kiosk of the variety commonly found in airports, railroad stations, and other public places through which large numbers of people pass on a daily basis. More specifically, the present invention is a kiosk combining content and convenience including digital content available for transfer to a portable device; connectors for charging portable electronic devices, including, but not limited to, tablet devices, such as the Apple iPad, cell phones, personal digital assistants (PDAs), and music and gaming devices; providing advertisements, news, weather, travel schedules and other targeted useful information; providing coupons and offers relevant to the location and user; and collecting and aggregating data related to those using it.

2. Description of the Prior Art

Kiosks are familiar fixtures in public places having a high volume of pedestrian traffic, and have been used for selling railroad tickets and the like in locations of this type.

In recent years, the use of cellular telephones, personal digital assistants (PDAs), tablet devices, netbooks and laptops, has grown to such a level that most working people have at least one of these portable devices, and many have several. Typically, these portable devices and others are sold with adapters for charging the batteries in the devices. The adapters, typically, include a transformer, rectifier, and connector, which fit into the device, and plug into a standard electrical outlet. In use, the adapter converts the AC electrical power supplied through the electrical outlet to DC power at considerably lower voltage for charging the battery in the portable device.

As anyone owning such a device can attest, the battery may require charging at the most inconvenient time, such as, when one is traveling and has left the required adapter at home. The owner of the device may then find himself in an unfortunate position, unable to make or receive telephone calls or to send or receive e-mail messages while away from home or office. The present invention has been designed to address this need felt, at one time or another, by all who own such devices.

Prior attempts to address this need are disclosed in several prior-art references, specifically British Publication No. GB 2 395 847 A, U.S. Pat. No. 5,744,933, International Publication No. WO 97/10638 A2, European Publication No. EP 0 905 962 A1, British Publication No. GB 2 379 547 A, U.S. Pat. No. 5,544,784, German Publication No. DE 100 64 960 A1, and British Publication No. GB 2 440 007 A. Each of these prior-art references shows a kiosk able to charge cell phones, but fails to show the enhanced functionality required as our society becomes more mobile, information-dependent and Internet-based.

While it is apparent that battery charging kiosks are known in the art, the present multi-function kiosk system provides many additional functions not previously available to users of kiosks, or the convergence of mobility and content that our world increasingly requires.

### SUMMARY OF THE INVENTION

Accordingly, the present invention is a kiosk which comprises a first display, a second display, and interactive interface for allowing a user to interact with the kiosk and select content for display on the second display. Computing is operatively coupled to the first display, second display and the interactive interface for storing content for display on the first and second displays, and for responding to input by the user on the interactive interface. A connection, operatively coupled to the computing is included to enable the kiosk to interact with a user's portable device. The first display, the second display, the interactive interface, the computing and the connection are enclosed and supported within an enclosure. Advertising content is stored on the computing means for display on the first display, and interactive content is stored on the computing for display on the second display.

The present invention is also a kiosk network which includes a central server and a plurality of the kiosks, which are operatively connected to the central server to provide two way data flow between the central server and a kiosk and between a kiosk and the central server.

The present invention has as one goal to provide a solution to this long-felt need for a multi-function kiosk system providing many additional functions not previously available to users of kiosks, along with the convergence of mobility and content that our world increasingly requires. It does so through a convergent kiosk, which provides content and functionality to mobile users and their portable electronic devices. One feature available is the charging of cellular phones, PDAs, or other personal electronic devices in busy public places. Other features include advertising, information on train and airplane schedules, local restaurant information, downloading of digital media content, and use of data relating to users of the kiosk, which provide revenue to its owners from advertisers and those interested in mining and aggregating the data for advertising and marketing uses. As will be discussed below, these additional functionalities are tailored to the location where the kiosk is disposed and operated. In the discussion to follow, the use of the kiosk in a newsstand in an airport will be highlighted as an example, although it should be understood that that the potential locations are much broader. In particular, the kiosks can be placed in fixed locations, such as pharmacies, universities, train and bus stations, and other retail locations, but can also be mobile event-driven kiosks, such as at a trade show, Super Bowl, or political convention.

Moreover, the present invention is much more than merely a kiosk for charging batteries in cell phones and PDAs, but is a system for advertising and selling a large number of products and services; providing targeted content and offering digital media downloads. The system is customizable in that it may be varied and tailored to the location of the kiosk. In this broad context, the cell phone charging capability of the kiosk, as well as a large display which continually displays advertising and location-specific video content, are intended to attract users to the kiosk, so that they may respond to the advertisements displayed thereon immediately by using the kiosk, and, in so doing, provide personal data about themselves for subsequent use by advertisers. In addition, there is an ability to provide offers or coupons for the kiosk's setting and proximate locations.

The invention accordingly comprises the features of construction, combinations of elements and arrangements of part and processes which will be exemplified in the constructions and processes as hereinafter set forth, and the scope of the invention will be indicated in the claims.

### BRIEF DESCRIPTION OF THE DRAWINGS

The present invention will be described below with frequent reference being made to the following figures.

FIG. 1 is a functional block diagram of a kiosk in accordance with the present invention;

FIG. 2 is a functional block diagram of a system of kiosks in accordance with the invention dispersed in a variety of locations;

FIG. 3 is a perspective view of a preferred embodiment of the kiosk of the present invention;

FIG. 4 is a view of what might be displayed on the touch screen of the kiosk before user interaction;

FIG. 5 is a view of the first image seen by a user of the kiosk on the touch screen when interaction is begun;

FIG. 6 is the first image seen by the user after choosing the phone charge function;

FIG. 7 shows the beginning of the terms of use displayed on the touch screen;

FIG. 8 shows another portion of the terms of use;

FIG. 9 is the image seen by the user after accepting the terms of use;

FIG. 10 is the image seen by the user after entering a four-digit secret code;

FIG. 11 is the image shown on the touch screen after the user has touched the “UNLOCK” icon in FIG. 10;

FIG. 12 is the image shown on the touch screen after the user has touched the “FINISH” icon in FIG. 11;

FIG. 13 is the first image seen by the user after choosing the retrieve phone function;

FIG. 14 is an image of a warning shown to the user when retrieving a cell phone;

FIG. 15 is the image seen by the user after touching the “OK” icon in FIG. 14;

FIG. 16 is the image seen by the user after entering a four-digit secret code;

FIG. 17 is the image shown on the touch screen after the user has touched the “UNLOCK” icon in FIG. 16;

FIG. 18 is the first image seen by the user after choosing the flight information function;

FIG. 19 is the image seen by the user after touching the “Departures” icon in FIG. 18;

FIG. 20 is the image seen by the user after touching the “Departure Times” icon in FIG. 19;

FIG. 21 is the image seen by the user after touching the “Find Another Flight” icon in FIG. 19;

FIG. 22 is the image seen by the user after touching the “Arrivals” icon in FIG. 18;

FIG. 23 is the image seen by the user after touching the “Arrival Times” icon in FIG. 22;

FIG. 24 is the image seen by the user after touching the “Find Another Flight” icon in FIG. 22;

FIG. 25 is the first image seen by the user after choosing the news function;

FIG. 26 is the image seen by the user after touching the “WORLD CLOCK” icon in FIG. 25;

FIG. 27 is the image seen by the user after touching the “SPORTS” icon in FIG. 25;

FIG. 28 is the image seen by the user after touching the “BUSINESS” icon in FIG. 25;

FIG. 29 is the image seen by the user after touching the “WEATHER” icon in FIG. 25;

FIG. 30 is the image seen by the user after touching the “US” icon in FIG. 29;

FIG. 31 is the image seen by the user after touching the “STOCKS” icon in FIG. 25;

FIG. 32 is the image seen by the user after choosing a particular stock in FIG. 31;

FIG. 33 is the first image seen by the user after choosing the help function;

FIG. 34 is an image seen by the user on the touch screen after the image in FIG. 33 has been displayed for several minutes; and

FIG. 35 is a view of a media cards reader and several types of memory devices which may be used therewith.

### DETAILED DESCRIPTION OF THE PREFERRED EMBODIMENT

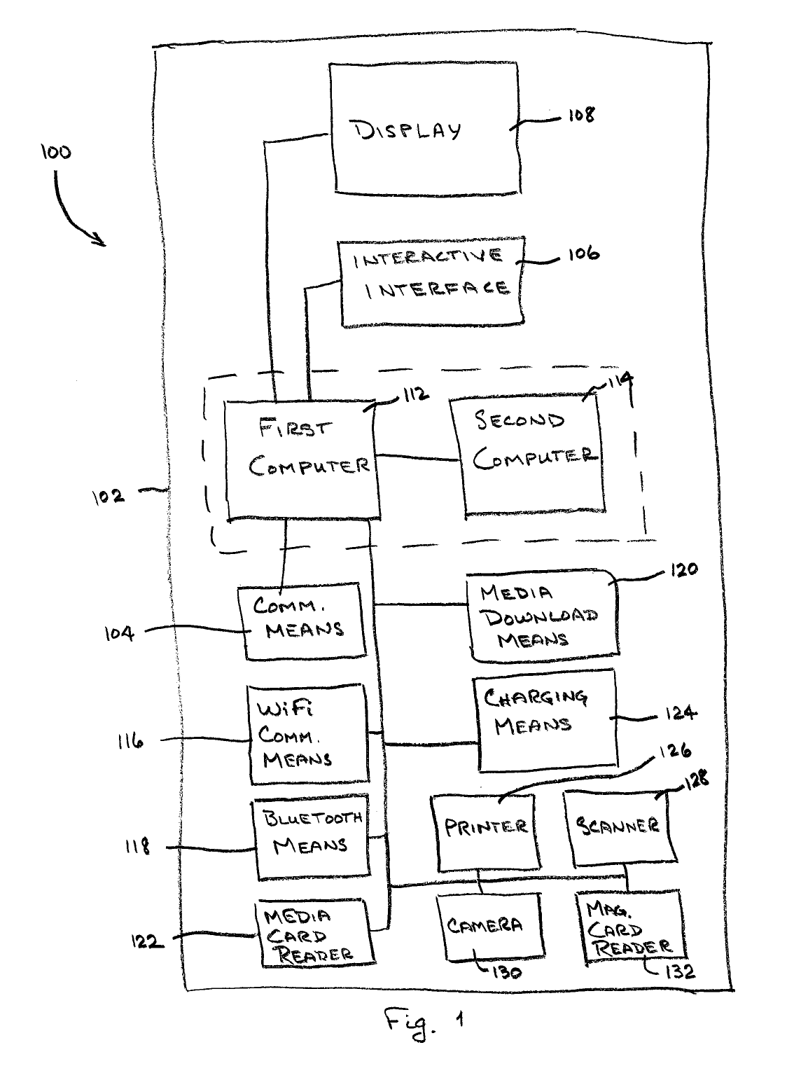

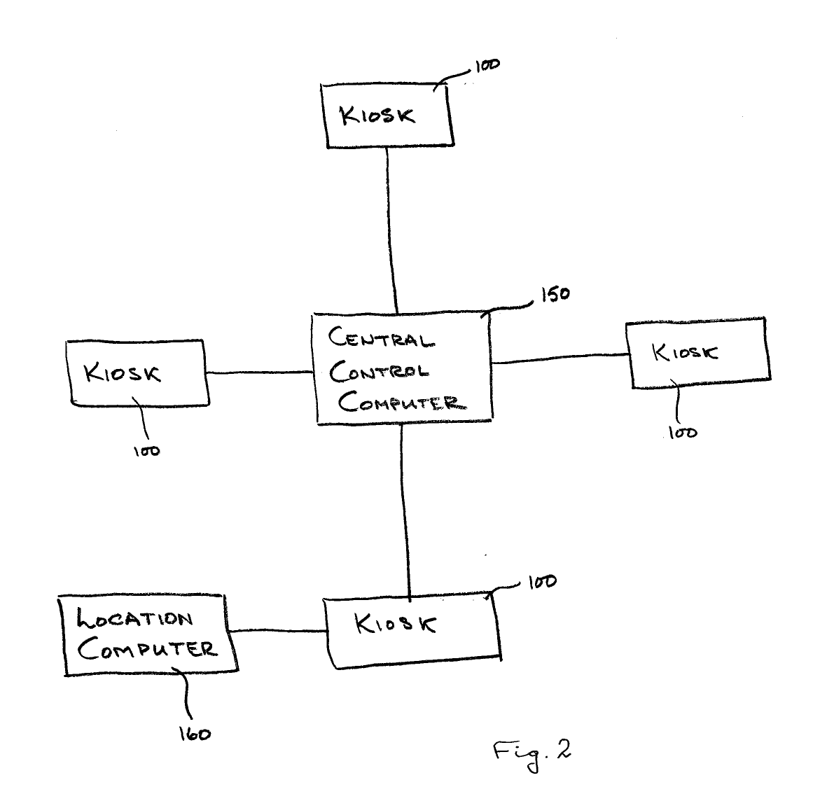

In preferred embodiments of the invention, the kiosk has several key components. FIG. 1 is a functional block diagram illustrating the components of the kiosk 100, and FIG. 2 is a functional block diagram of a system 140 of kiosks 100 dispersed in a variety of locations.

With reference to FIGS. 1 and 2, the kiosk 100 includes a structural enclosure 102, which may enclose one or more computers and other hardware components in an attractive manner for location in a public place. Alternatively, the computer or computers may be located remotely, that is, not within the structural enclosure 102, and may in such a case operate the kiosk 100 through a communication means 104 within the enclosure 102.

The kiosk 100 also includes an interactive interface 106, which can be a touch screen, keyboard or both, or other interface including a voice-activated interface; and a large display 108 for use in connection with advertising.

For the purposes of the present discussion, the computer 110 within the structural enclosure 102 comprises a first computer 112 and a second computer 114. First computer 112 may be used to control the interactive interface 106 and display 108. Communication means 104, which may be wired or wireless, enables first computer 112 to remain in communication with a central control computer 150 at another site, whereby it may update the advertisements shown on the display 108, and possibly extending onto the interactive interface 106, with location- and time-specific content. At the same time, communication means 104 forwards data on the use of the kiosk 100 to the central control computer 150 for subsequent analysis. WiFi communication means 116 and Bluetooth communication means 118, both also operatively connected to first computer 112, enable users of the kiosk 100 to communicate with the kiosk 100 using their own mobile devices, so that those devices may function as an extension of the interactive interface 106, thereby enabling several users to interact with the kiosk 100 at the same time, so that, for example, the users may make purchases at the retail outlet where the kiosk 100 may be located. In this way, the likelihood of a line forming at a kiosk 10 with the consequence that people will leave the location out of frustration may be reduced. The WiFi or Bluetooth communication may be limited to communications with the kiosk 100 itself, or may enable full Internet communication, as desired. In some preferred embodiments, the user would use the kiosk interface screen on his or her portable device's screen.

Second computer 114 may be dedicated to storing media content for download onto user devices. Such local storage will enable extremely fast downloads of media content to be provided to users. Alternatively, or in addition to local media storage, content may be downloaded onto user devices over the Internet from the central control computer 150 through the communication means 104.

Users may obtain digital media for their portable electronic devices, either by media download means 120, which transfers the digital content directly onto the portable electronic devices, or by media card reader 122, which downloads the desired digital media onto one of the commonly used memory devices, which may be attached, plugged into, or inserted in the user's portable electronic device.

Kiosk 100 also includes a charging means 124 for charging the battery in a user's portable electronic device, such as a cell phone, personal digital assistant, such as a Blackberry, netbook, or the like. Kiosk 100 further includes a printer 126, which may be used to print coupons, offers, tickets, photographs, e-mail messages, and any other content that a user may obtain by using the kiosk, in color or in black and white. In addition, a scanner 128 is included to enable a user to scan any barcode, uniform product code (UPC), coupon, boarding pass, enabling the kiosk 100 to print an offer or e-mail it to the user.

A camera 130 is also included in the kiosk 100. The camera 130 may be used to characterize the actual audience in front of the kiosk 100 at any given time, in terms of gender and age, and can be used to offer picture taking and printing, and for security purposes. It may also be employed to target audiences for gender and/or age specific advertisements.

Finally, a magnetic card reader 132 is provided so that a user may pay for such purchases as digital content with credit or debit cards.

The possible locations for the kiosk 100 and variety of functions with which it may be provided are very broad. Reference is now made to FIG. 2, which is a functional block diagram of a system of kiosks 100 dispersed in a variety of locations. That only four are shown, it should be understood, is for the purpose of illustration. In reality, many kiosks 100 are dispersed in a variety of locations of different types.

The system 140 of kiosks 100 includes central control computer 150 at a location remote from the kiosks 100. The central control computer 150 is in communication with the dispersed kiosks 100 through wireless or wired communication means included in each. In a currently preferred embodiment, the communication means in each kiosk 100 updates the central control computer 150 on its activity every five seconds, keeping track of every action made using the interactive interface 106 of each kiosk 100 by users. Information provided by users, such as their e-mail addresses and other pertinent personal information, namely, addresses, telephone numbers, genders, ages, income levels, which they may input into the kiosk 100 via the interactive interface 106, is also transmitted to the central control computer 150. Each kiosk 100, as previously noted, includes a camera 130, which may be used to take and transmit an image of the user to the central control computer 150. The image may then be analyzed to determine and profile the individual user's gender and approximate age. All of this information will then be available to mine people's preferences, target advertising and advertisements, by brand, by time, by user, and can also be monetized by “selling” the information to advertisers or other companies that monetize personal information, such as blast lists, AMEX, and others.

Local communication at the site of a kiosk 100 may also include communication between the kiosk 100 and a location computer 160, that is to say, a computer at the specific location of the kiosk 100. Such a computer 160 may be one tied into the cash registers at a retail outlet, such as a newsstand. When this particular capability is provided, a user of the kiosk 100 may respond to an advertisement shown on the display 108 for a product available at the retail outlet by purchasing it at the kiosk 100, perhaps using a credit or debit card, by printing out a receipt using the printer 126, and by presenting the receipt at the cash register after finding the item of interest in the retail outlet.

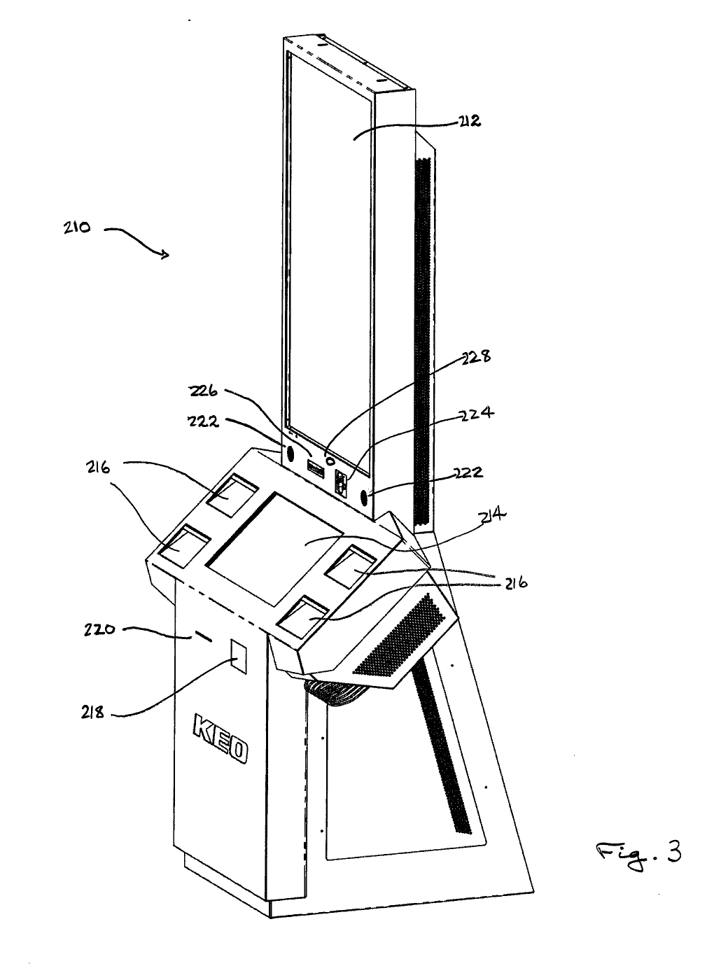

With reference to FIGS. 3 through 35, the embodiment and functionality in connection with a current preferred embodiment of the kiosk system as used in one specific type of location, that of a newsstand in an airport, is shown. The various functions that will be described below are tailored to that location, but would not necessarily be used in a location of another type. The user may log on to the kiosk system, if a certain functionality is required. One way to log on is to enter an e-mail address, which may be checked to verify that it is a current working address by the computer, before the user is able to proceed.

Turning now to these figures, FIG. 3 is a perspective view of a preferred embodiment of a kiosk 210 of the present invention. The kiosk 210 includes a display 212 on which a variety of information may be displayed to passersby, such as greetings from the proprietors of the location of the kiosk 210 and advertisements.

Display 212 may, for example, be a high-definition 46-inch screen (diagonally measured and having a 16:9 ratio) mounted in a vertical or portrait orientation and having stereo sound capability. Screens of this variety may be obtained from NEC Display Solutions of Itasca, Ill., or from other high definition TV monitor display manufacturers. The entire screen area may be used to display the desired images, or the screen area may be divided into top, middle and bottom portions, or other configurations, where separate images, perhaps coordinated, may be displayed.

The display 212 may be used to display advertisements or other images and information in a loop of any desired overall length. Individual advertisements may, for example, be of any desired length, and presented in a full-screen or split-screen format as suggested above. Other content, such as news or stories of local interest, may be interspersed with the advertisements. Advertisements may also be displayed based on the interactions the user has with the kiosk 210.

For example, a four-minute repeat loop may be used for display 212. Such a repeat loop may include 1.5 minutes of original programming, such as site-specific information, and ten 15-second advertisements, all repeating fifteen times per hour. The site-specific information, which may be marketing and promotion for the location of the kiosk 210, will then repeat fifteen times per hour.

The kiosk 210 in a currently preferred embodiment includes two computers 112,114, one of which controls display 212 and stores the information being displayed thereon. The kiosk 210 may be configured such that the same computer controls the information displayed on touch screen 214. In such a case, the information displayed on the display 212 may extend downwardly to continue in a coordinated manner on touch screen 214. Kiosk 210 further includes a touch screen 214; several charging drawers 216, in which cell phones, PDAs, or gaming devices may be connected for charging; a bar-code scanner 218 for reading one- or two-dimensional bar codes; a printer 220 within kiosk 210 for printing a receipt or other output; stereo speakers 222; a magnetic card reader 224 for credit and debit cards; a media card reader/writer 226; and a digital camera 228.

Touch screen 214 may, in a currently preferred embodiment, be a Planar PT 22 Touch Screen which is available from Planar Systems, Inc. of Beaverton, Oreg. Touch screen 214 is a 22-inch touch screen (diagonally measured) having a 16:9 length-to-width ratio. It is used in a horizontal or landscape orientation in the kiosk 210. Different sizes and configurations are possible depending on the anticipated use.

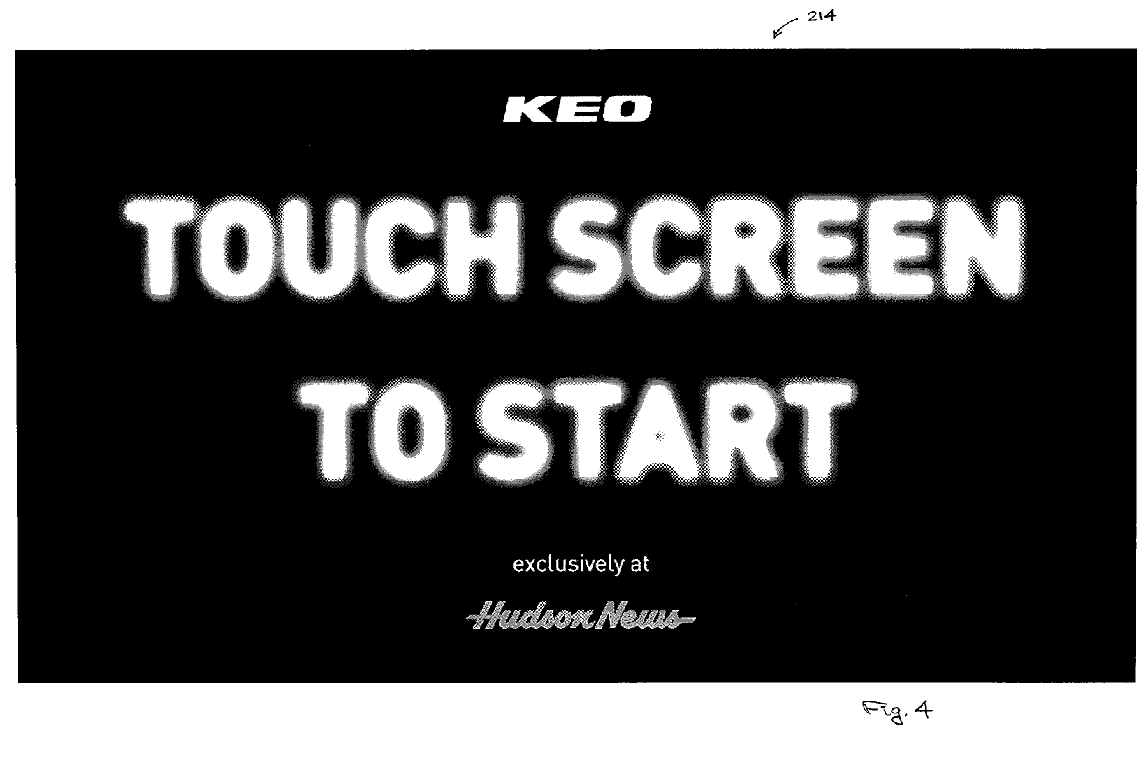

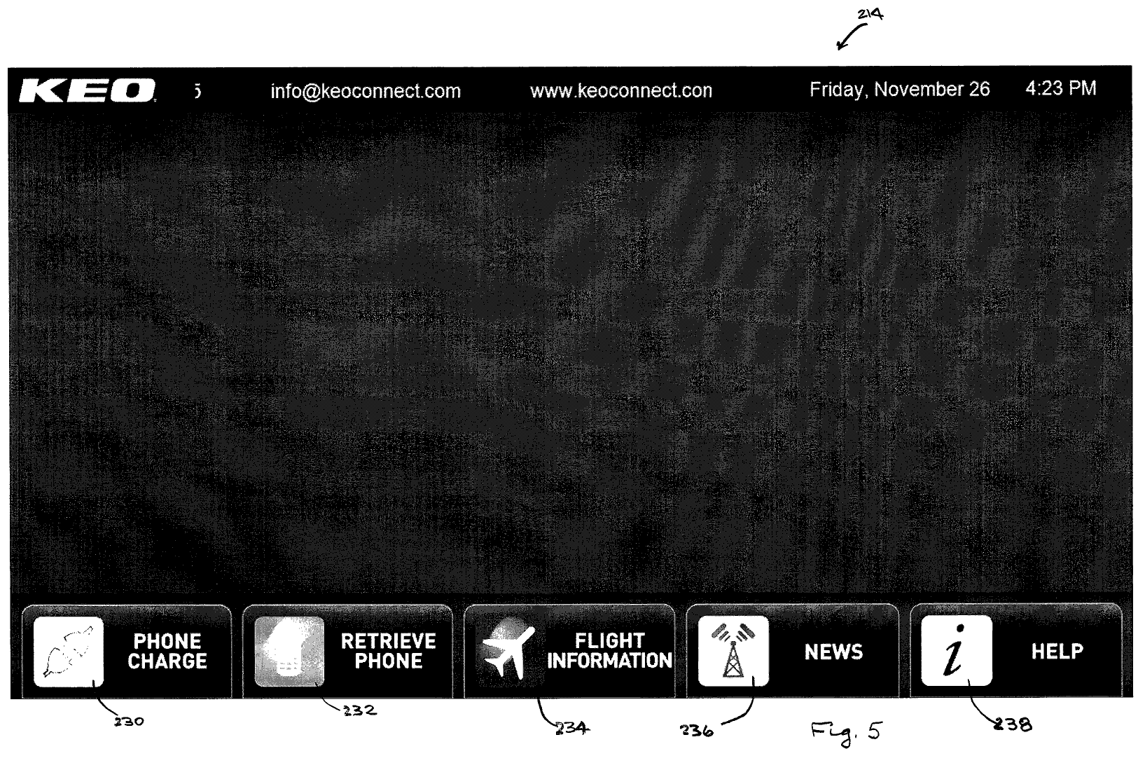

FIG. 4 is a view of what may be displayed on touch screen 214 before a user has begun to interact with kiosk 210, KEO being a provider of the kiosk 210 and Hudson News, which operates newsstands in many airports in the United States, refers to a location of the kiosk 210. When the user has decided to interact with the kiosk 210, he or she touches the screen as instructed, and is presented with an image like that shown in FIG. 5.

Arranged across the bottom of the image shown in FIG. 5 are icons relating to various functions of the kiosk 210. The labels on the icons are self-explanatory: the user would press one of them to charge or retrieve a telephone or other device, or to obtain required information. It should be understood that the kiosk 210 may be provided with additional functions beyond those indicated. In that event, additional icons would be arranged along the bottom of the touch screen 214. Some of those additional functions will be discussed below.

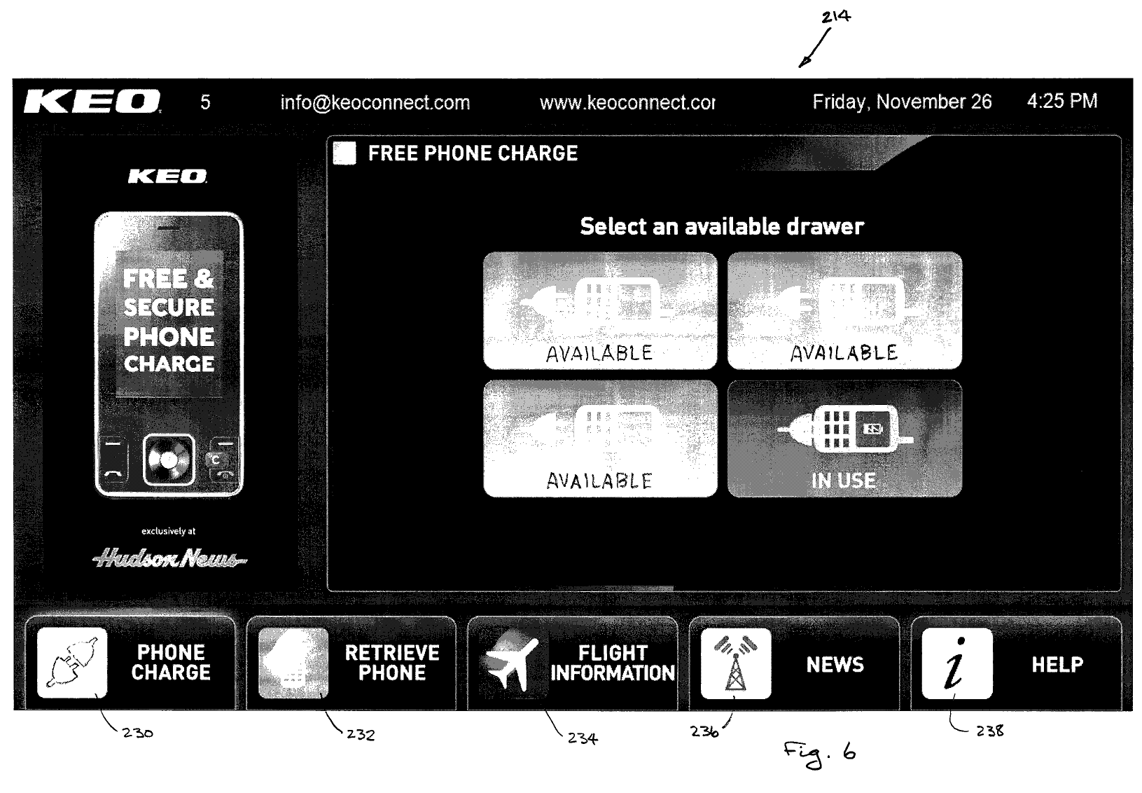

For the moment, let us assume that the user wishes to have the battery in his or her cell phone or PDA charged. To proceed, the user would touch the phone charge icon 230. Having done so, the touch screen 214 may display an image like that shown in FIG. 6.

In FIG. 6, the user is presented with four additional icons corresponding to the four charging drawers 216 of the kiosk 210 and arranged in corresponding relative positions. It will be noted that one of the four additional icons indicates that the charging drawer 216 on the lower right-hand side is in use. The user, then, must use one of the remaining three charging drawers 216. If it should happen that all four of the charging drawers 216 are in use, all four additional icons will so indicate. The user then has the choice of touching one of the other icons arranged across the bottom of the touch screen 214, or of walking away. If he or she does the latter, the touch screen 214 will display the image shown in FIG. 4 after a suitable amount of time.

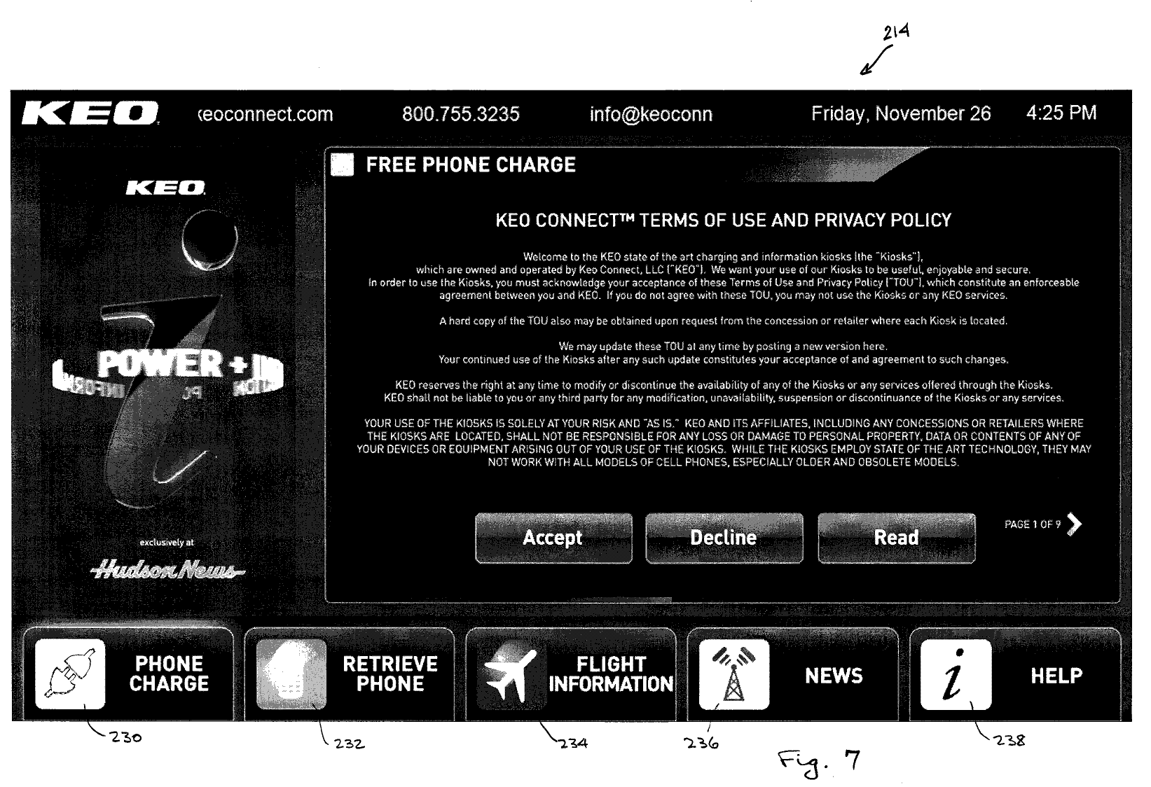

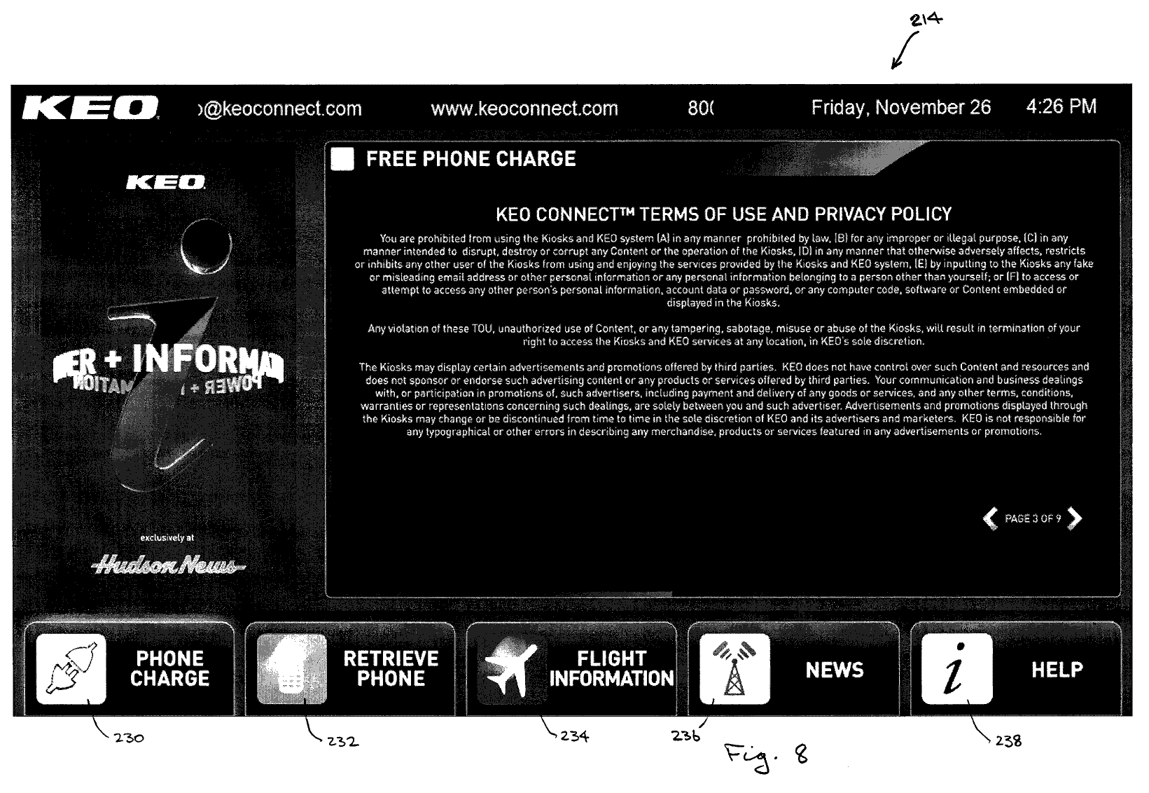

If the user touches one of the other three icons in FIG. 6, he or she will be presented with the “KEO CONNECT™ TERMS OF USE AND PRIVACY POLICY” shown in the image displayed in FIG. 7. It will be noted that these “Terms of Use” are nine pages long, page 3 being shown in FIG. 8. The user may scroll back and forth through these “Terms of Use” using the arrows at the bottom of the right-hand side of the image if he or she touches the “Read” icon, but, in any event, must touch either the “Accept” or “Decline” icons. If he or she touches the “Decline” icon, he or she will not be able to charge a device and, after a suitable amount of time, the touch screen 214 will again display the image shown in FIG. 4.

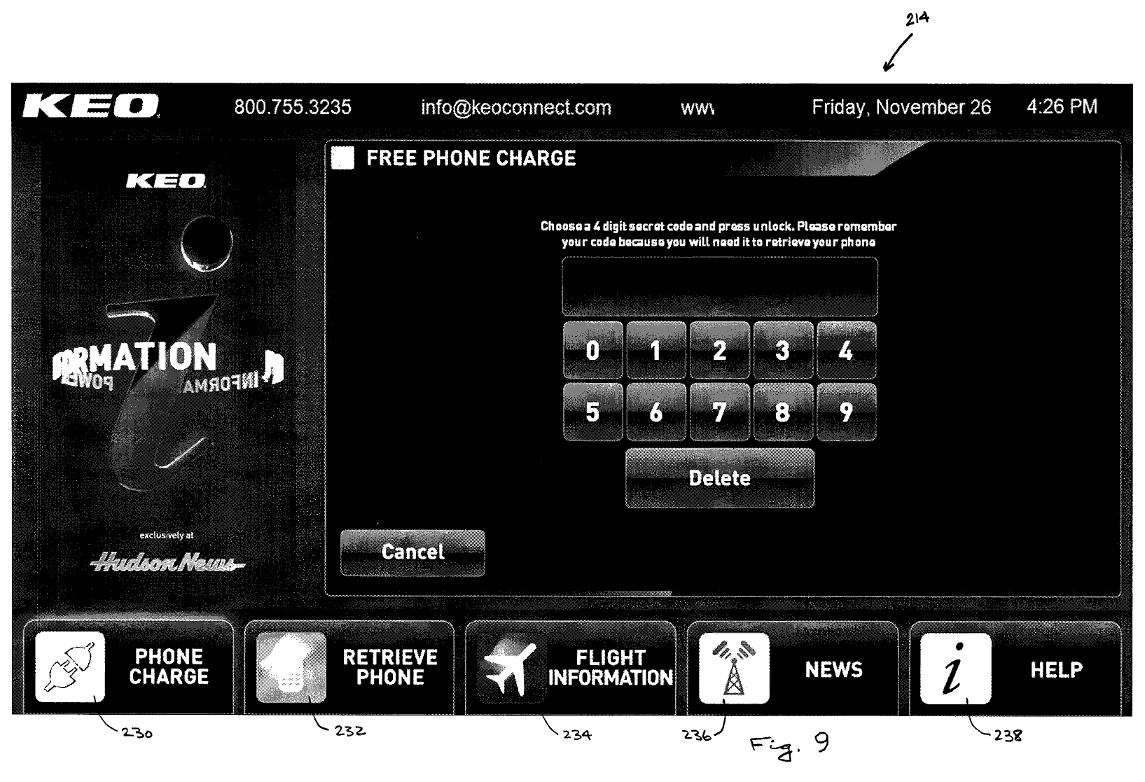

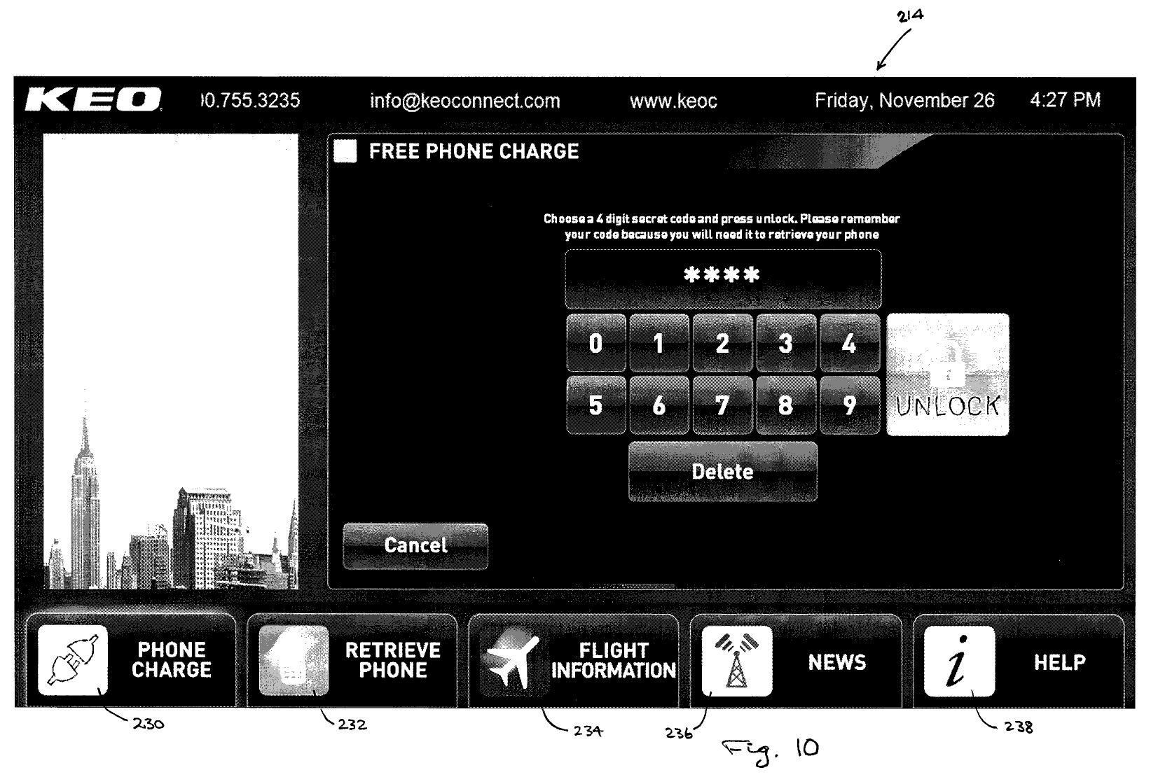

Assuming that the user has touched the “Accept” icon, the image shown in FIG. 9 will be displayed. This image requests the user to enter a four-digit secret code, which will be needed to retrieve the telephone to be charged. The “Delete” icon functions like a backspace to correct errors; the “Cancel” icon is used if the user has changed his or her mind about recharging. Having entered a four-digit secret code, the image shown in FIG. 10 is shown. By touching the “UNLOCK” icon, the previously chosen charging drawer 216 will be unlocked. In a sense, the word “drawer” is a misnomer because the charging drawer 216 does not open and close like a drawer in a piece of furniture. Rather, the charging drawers 216 are more like compartments or “cubbies”, which are accessed by opening doors in a downward direction at the four indicated places on the front of the kiosk 210.

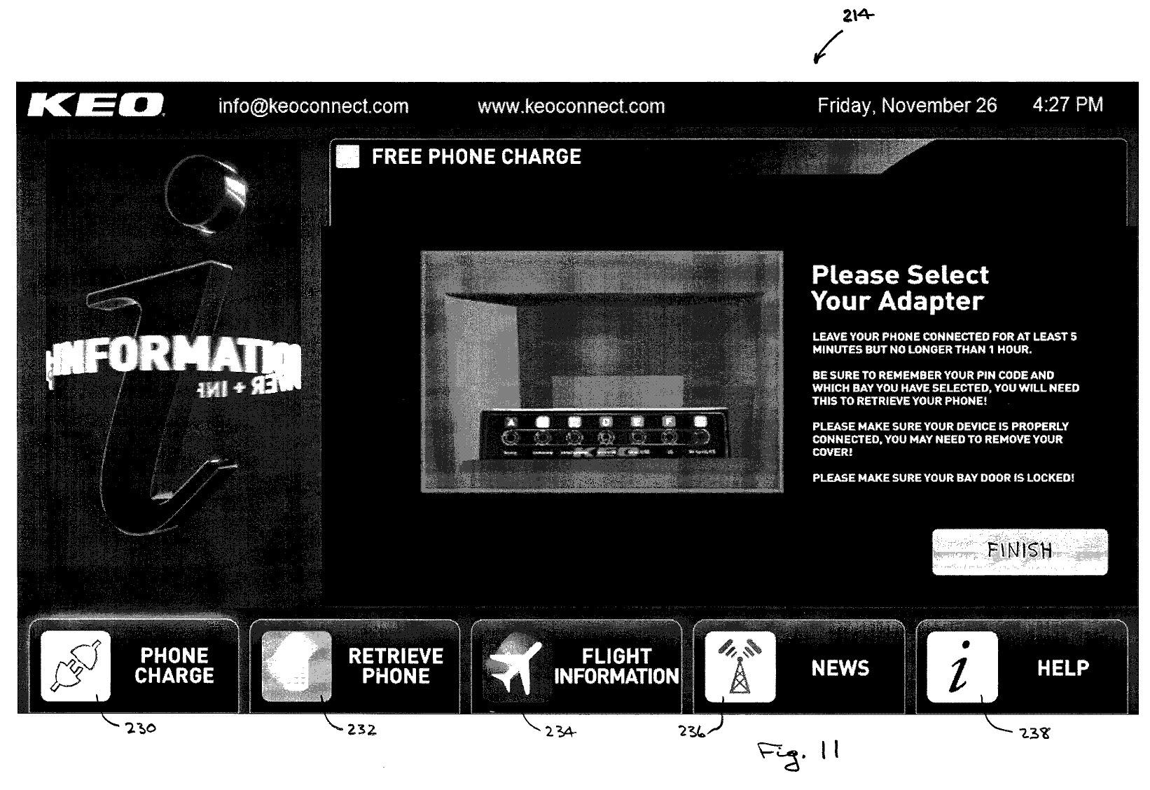

Having touched the “UNLOCK” icon in FIG. 10, the image shown in FIG. 11 appears on the touch screen 214. FIG. 10 includes an image of the inside of one of the charging drawers 216, each of which includes seven charging adapters labeled “A” through “G”. Charging adapters “A” through “F” are the six most commonly used adapters for cell phones and PDAs, accommodating all of the most popular cell phones and PDAs, such as Blackberries. The seventh charging adapter “G” is of the type used to charge the Nintendo DS portable gaming system. The user must hold the door open and connect his or her cell phone, PDA, or gaming system to the appropriate charging adapter. Once the device is connected, the door is closed, and the charging compartment 216 locks automatically.

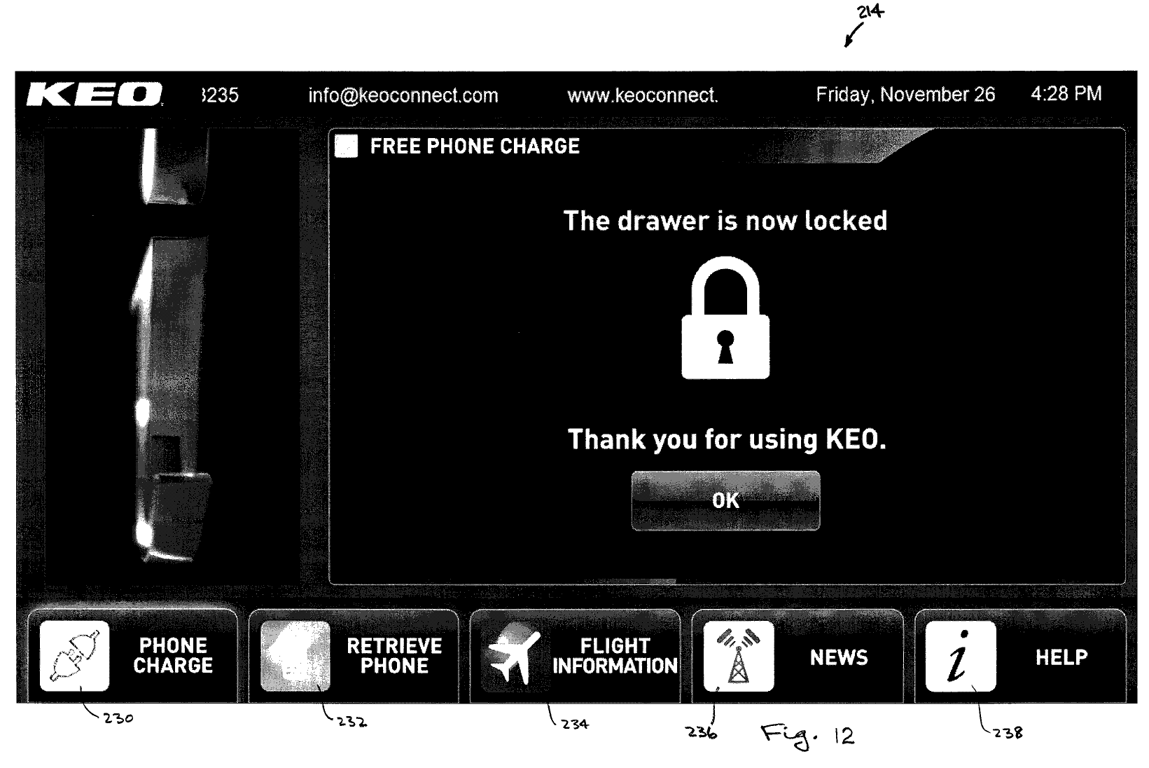

When the door is closed, and the “FINISH” icon in FIG. 11 is touched, the touch screen 214 displays the image shown in FIG. 12, advising the user that the charging drawer 216 is locked. When the user touches the “OK” icon, the charging session begins, and the user can leave the kiosk 210 and allow the device to be charged for the time available to the user.

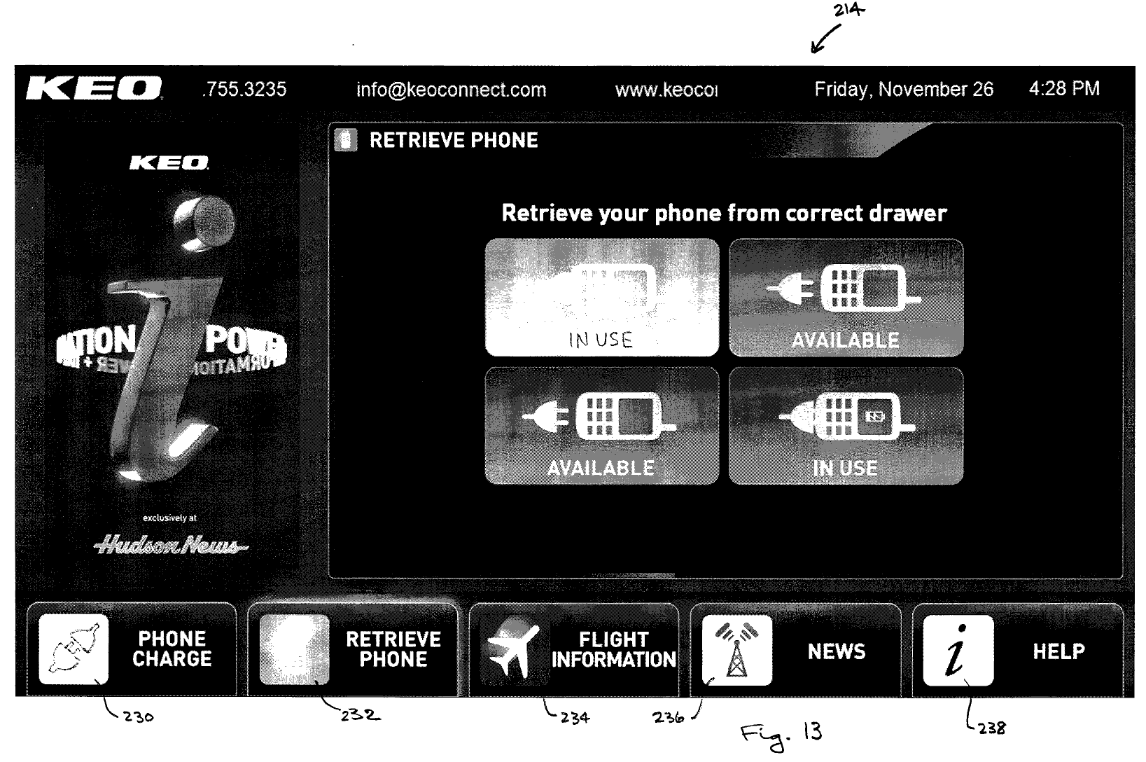

When the user wishes to retrieve the device being charged, he or she must return to the kiosk 210. The touch screen 214 will appear as shown in FIG. 4, and, when the touch screen 214 is touched, it will appear as shown in FIG. 5. The user will then touch the retrieve phone icon 232. The image shown in FIG. 13 will then be shown on the touch screen 214.

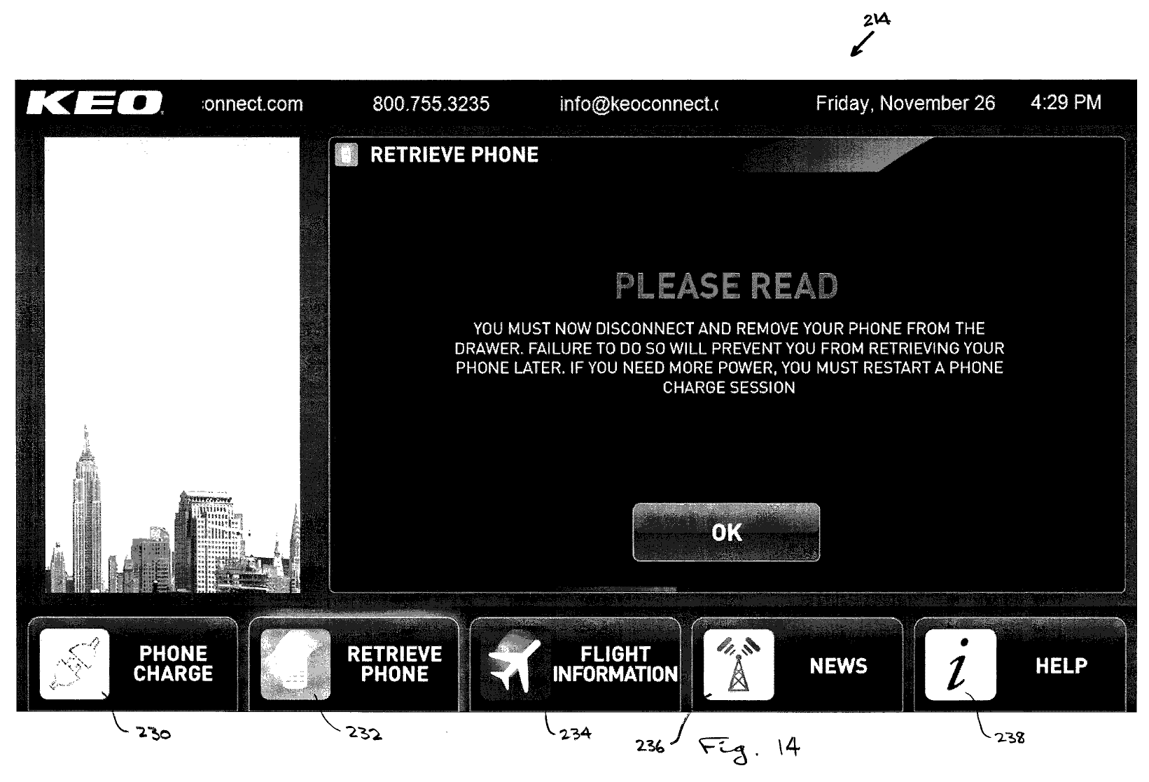

Of course, the user must remember not only the four-digit secret code entered when the device was left for charging, but also the charging compartment 216 it was left in, as two of the four charging compartments 216 are indicated as being in use. Once the user makes his or her choice, the touch screen 214 displays the image shown in FIG. 14. The message on the touch screen 214 is important because, assuming that the user looked at his device and saw that further charging was required, if he or she simply left it there for further charging and shut the door, the previously chosen four-digit secret code would no longer work and the device could not be retrieved. That is why the user is told, by the image in FIG. 14, to start a new charging session in the manner described above, and to touch the “OK” icon to proceed.

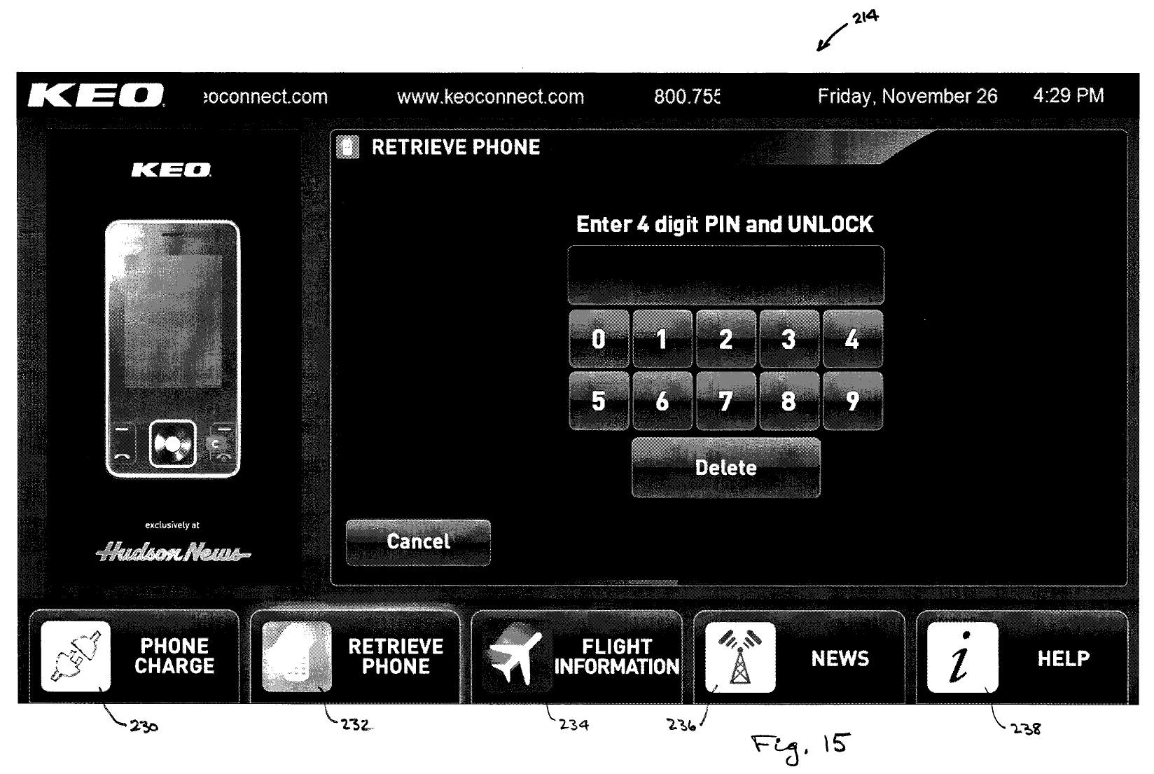

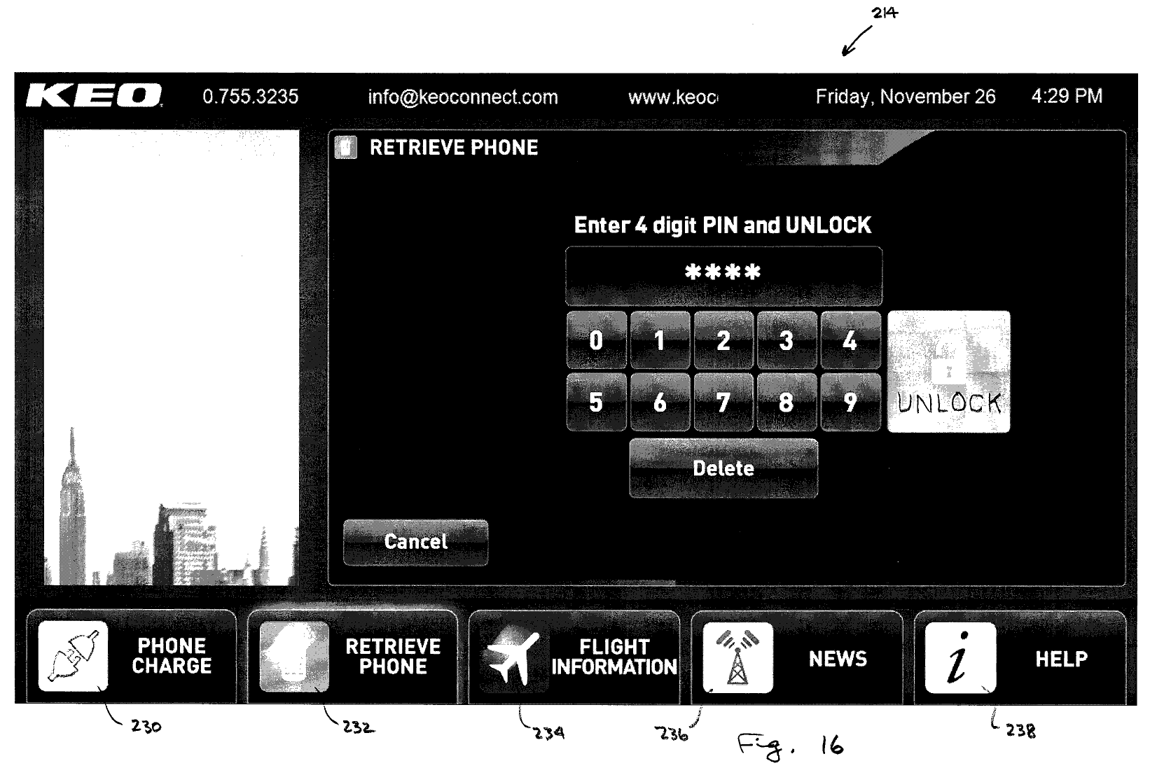

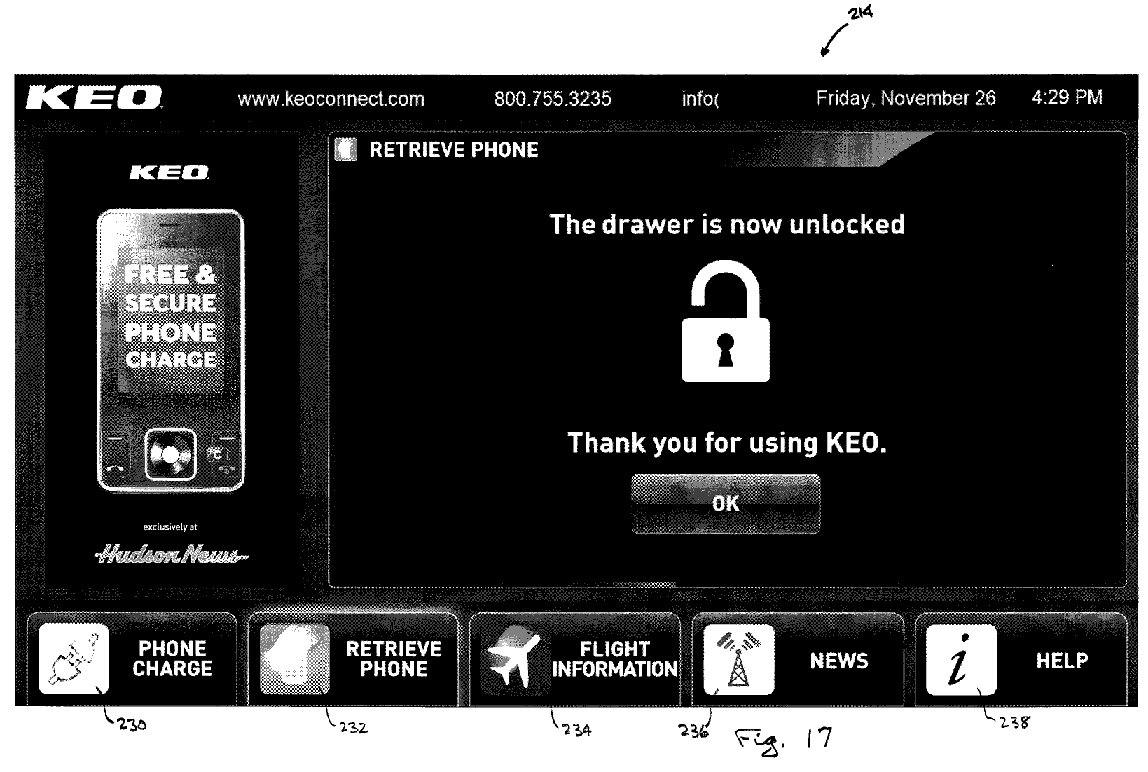

Then the user is presented in FIG. 15 with an image like that shown in FIG. 9 with instructions to enter the previously entered four-digit secret code (PIN), and, when this has been done successfully, the user is presented in FIG. 16 with an image like that shown in FIG. 10 with instruction to touch the “UNLOCK” icon to retrieve the device. When the “UNLOCK” icon is touched, the touch screen 214 shows the image in FIG. 17 saying that the charging drawer 216 has been unlocked.

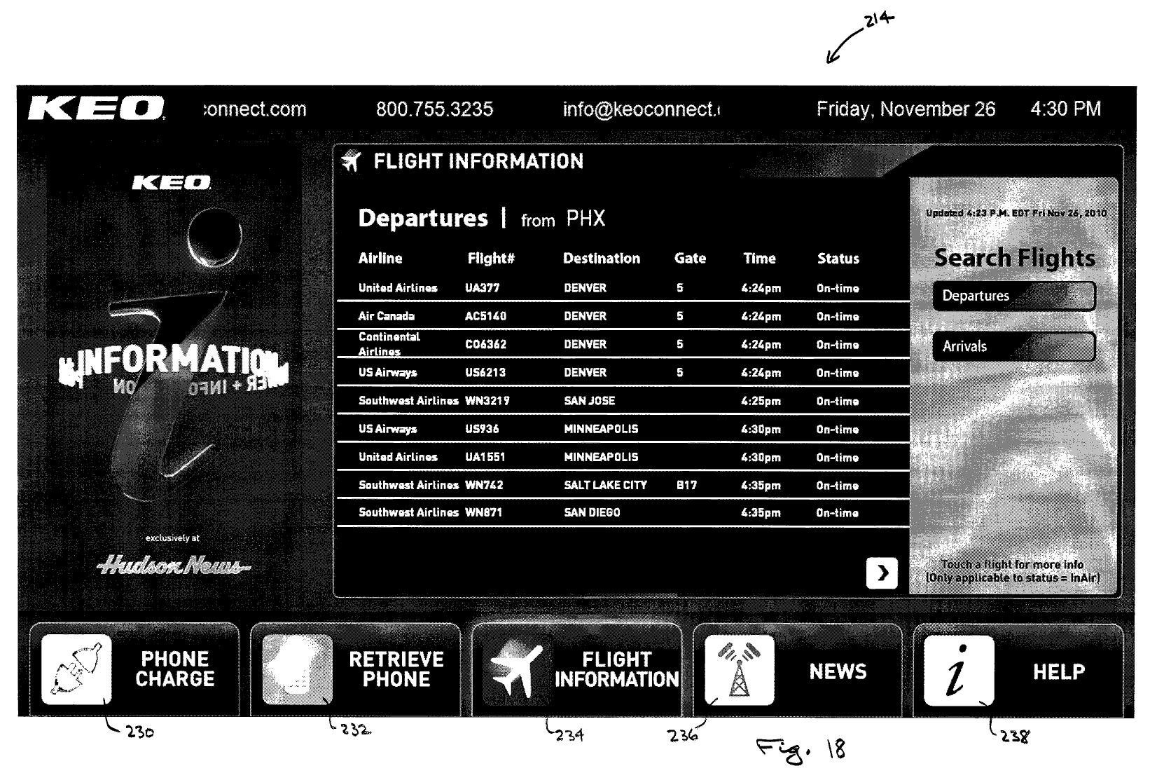

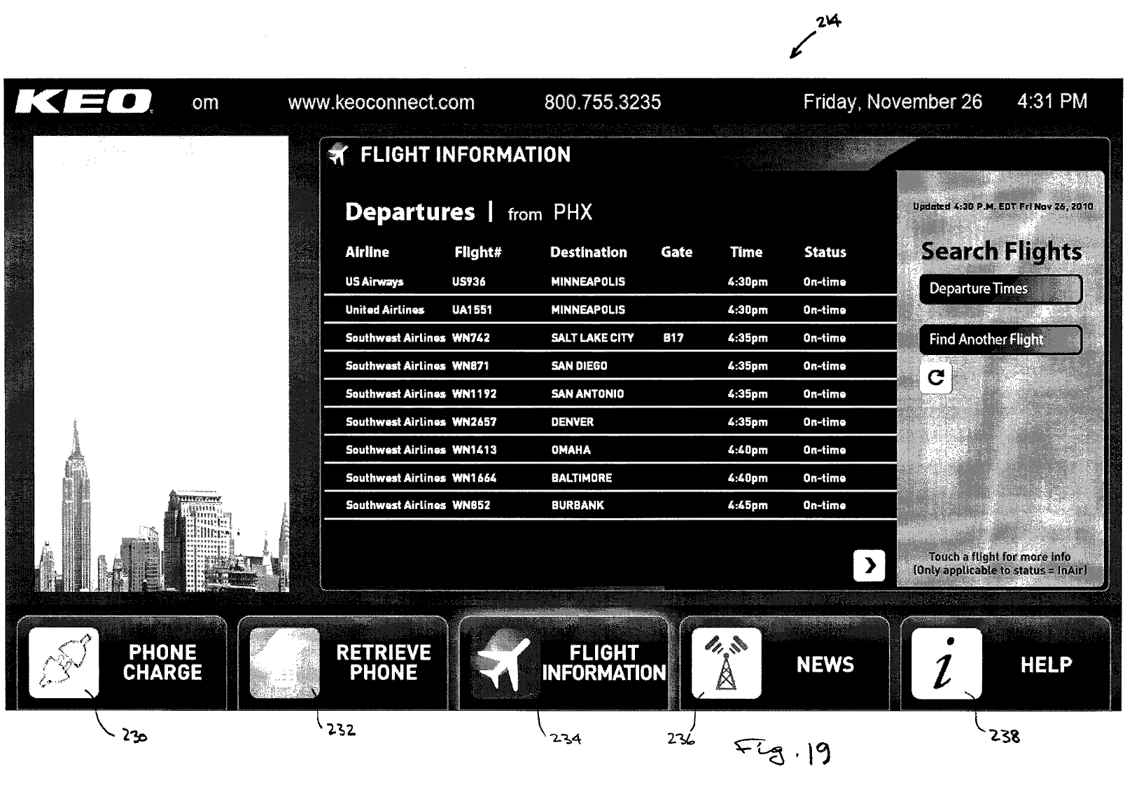

If the user is interested in obtaining flight information, he or she can touch flight information icon 234, as shown in FIG. 5 and subsequent figures, to obtain the image on the touch screen 214 shown in FIG. 18. FIG. 18 shows an airport-specific listing of flight departures within several minutes before and after the current time. At this point, the user can either search for information on departures or arrivals by touching the appropriate icons on the touch screen 214 in FIG. 18. When the “Departures” icon in FIG. 18 is touched, additional departures are shown in an image like that of FIG. 19.

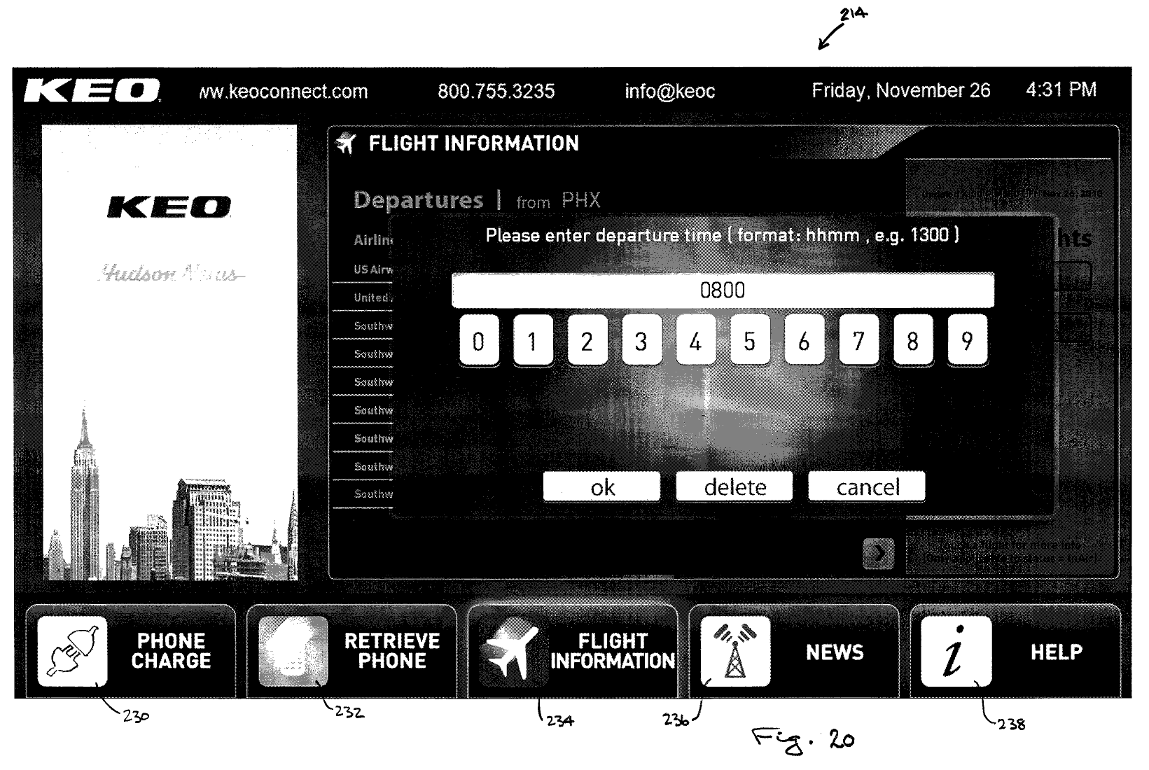

On the right-hand side of the image shown in FIG. 19 are additional icons for departure times and for finding another flight. If the “Departure Times” icon is touched, the user is presented with the image shown in FIG. 20. Using the touch screen 214, the user can then search for any flights departing at a specific time.

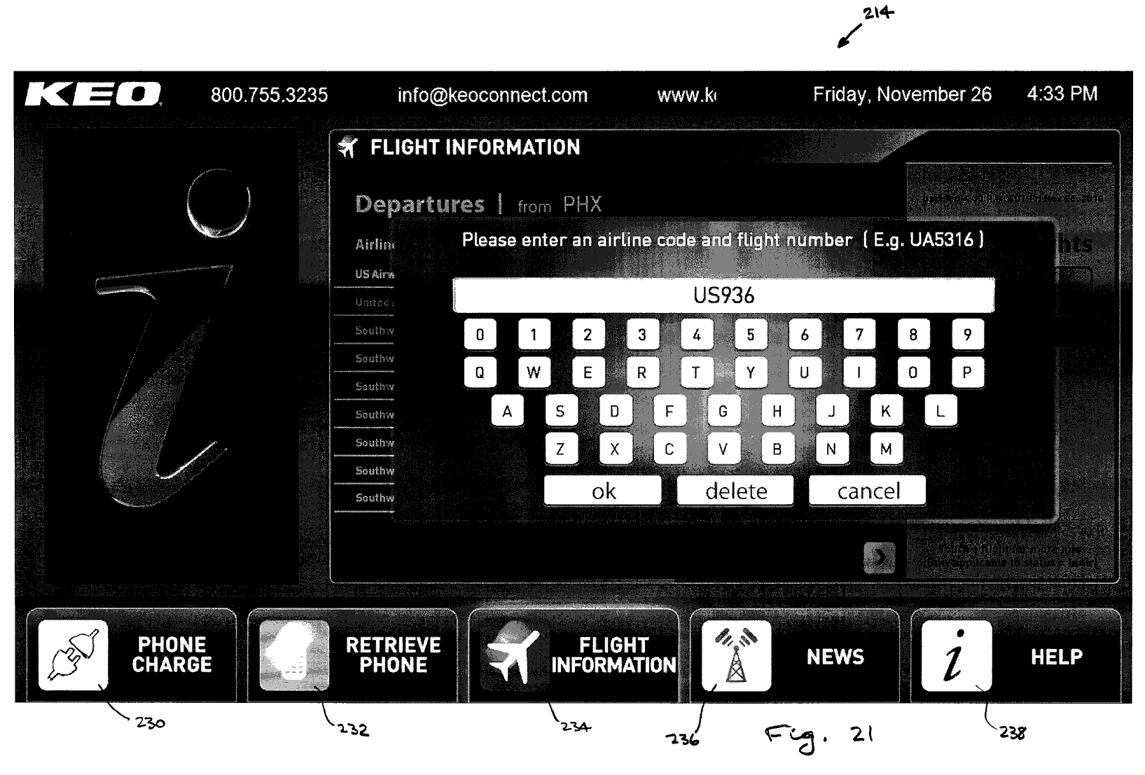

On the other hand, if the “Find Another Flight” icon is touched, the user is presented with the image shown in FIG. 21. Using the touch screen 214, the user can then search for any specific departing flight by airline code and flight number.

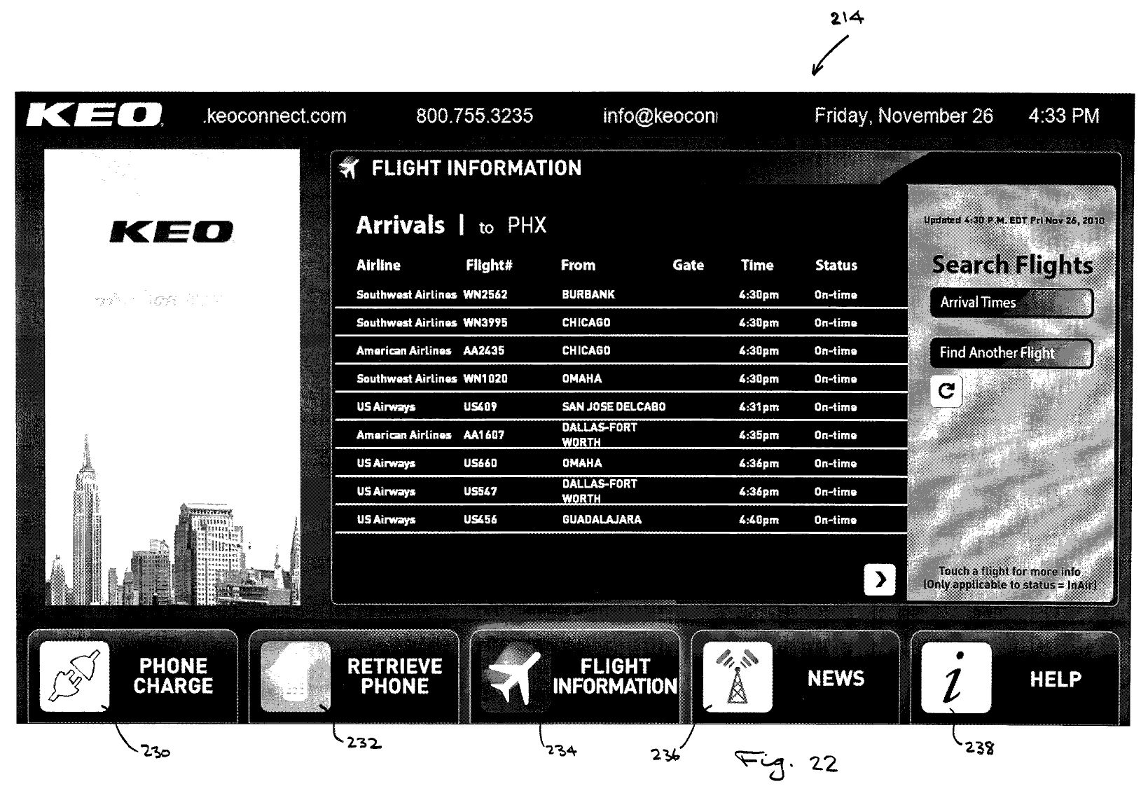

Similarly, when the user is viewing the initial flight information image in FIG. 18, he or she can search for information on arrivals by touching the “Arrivals” icon on the right-hand side of the image below the “Departures” icon. Having done so, arrivals within several minutes before and after the current time are shown in an image like that of FIG. 22.

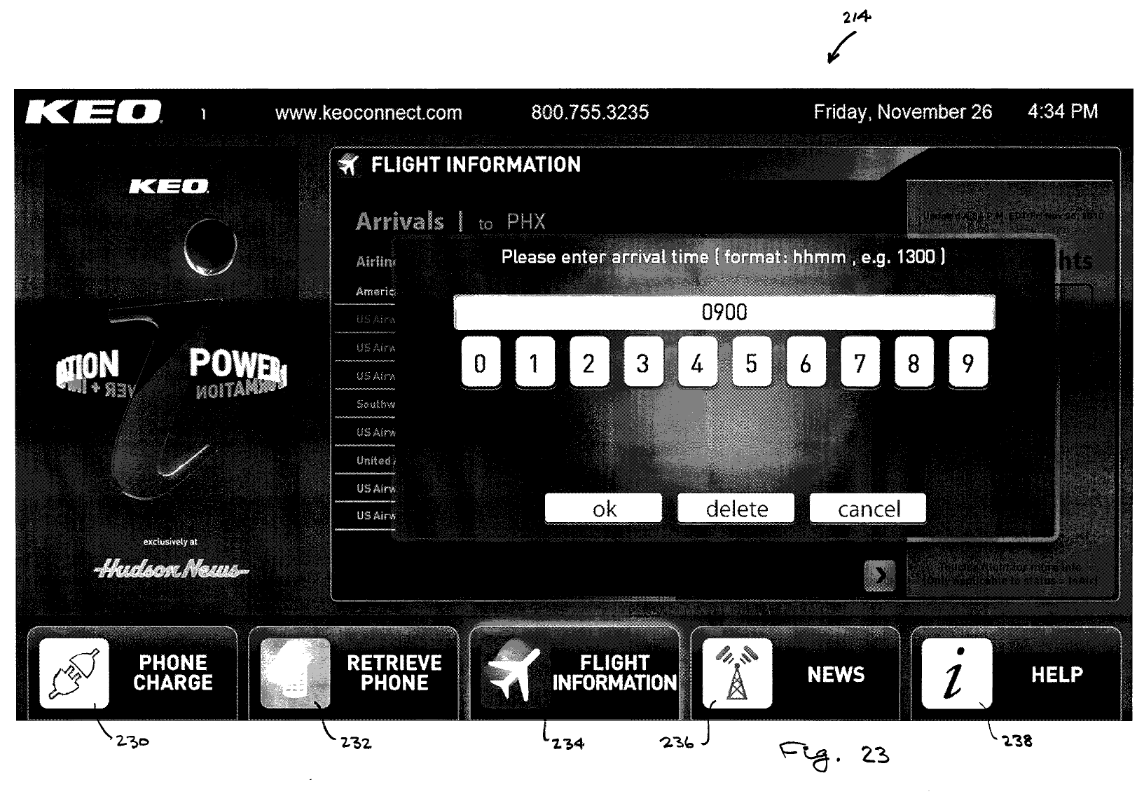

On the right-hand side of the image shown in FIG. 22 are additional icons for arrival times and for finding another flight. If the “Arrival Times” icon is touched, the user is presented with the image shown in FIG. 23. Using the touch screen 214, the user can then search for any flights arriving at a specific time.

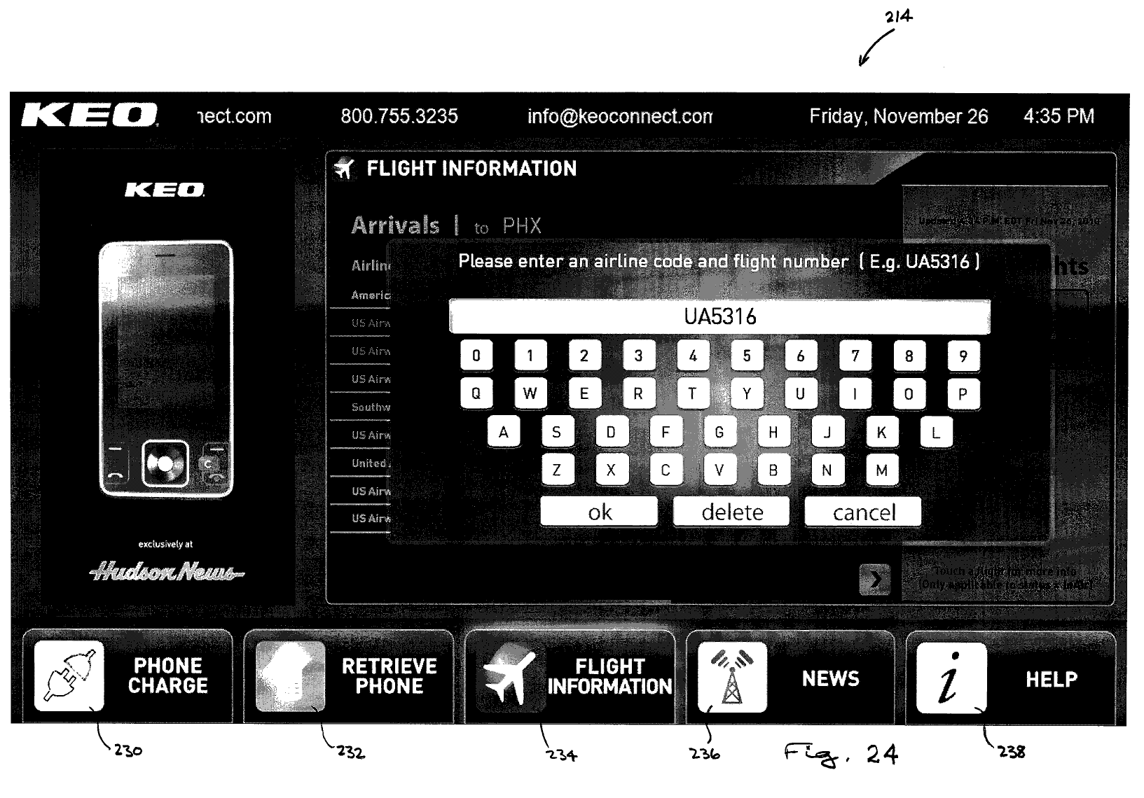

On the other hand, if the “Find Another Flight” icon is touched, the user is presented with the image shown in FIG. 24. Using the touch screen 214, the user can then search for any specific arriving flight by airline code and flight number.

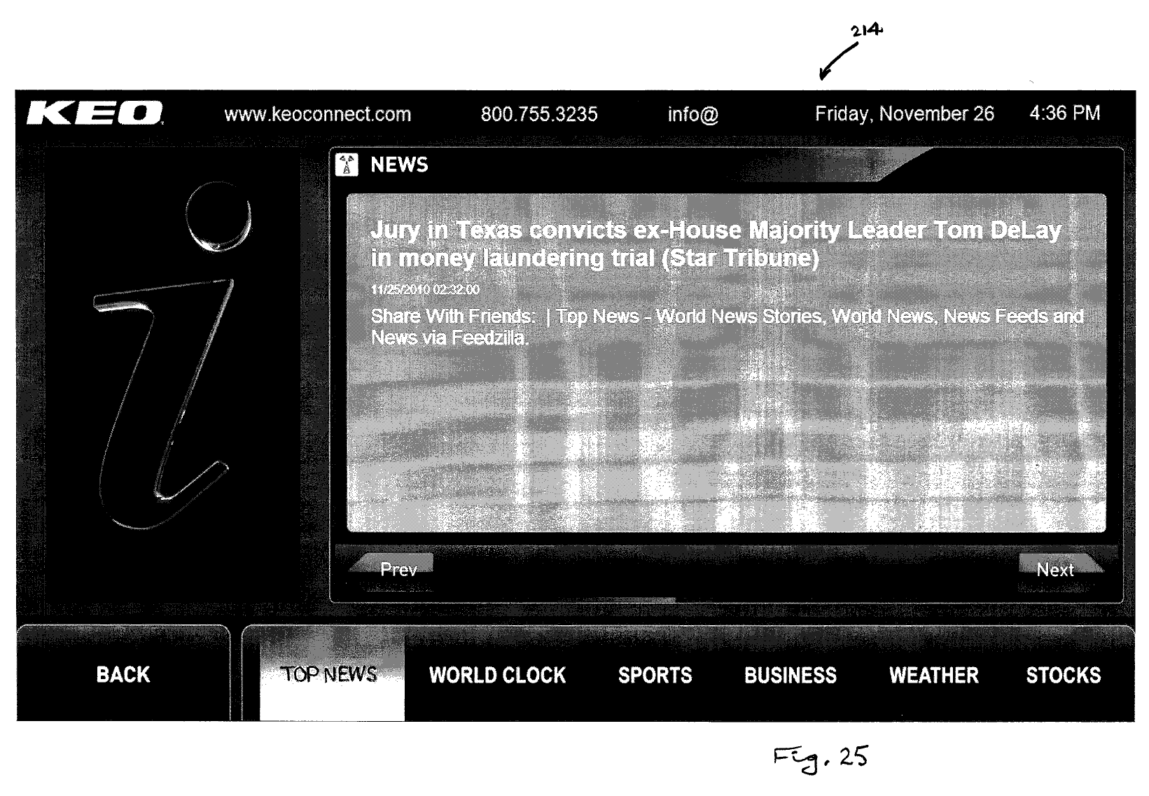

If the user is interested in obtaining news, he or she can touch the news icon 236, as shown in FIG. 3 and subsequent figures, to obtain the image on the touch screen 214 shown in FIG. 25.

Referring more particularly to FIG. 25, it will be noted that there are several new icons arrayed across the bottom of the touch screen 214. Firstly, by touching the “BACK” icon at any time, the user will be returned to the image on the touch screen 214 shown in FIG. 5.

By touching the “TOP NEWS” icon, the user can, by touching the “Prev” and “Next” icons, scroll through the most current top news stories, which are obtained by means of an RSS feed and updated at two-minute intervals.

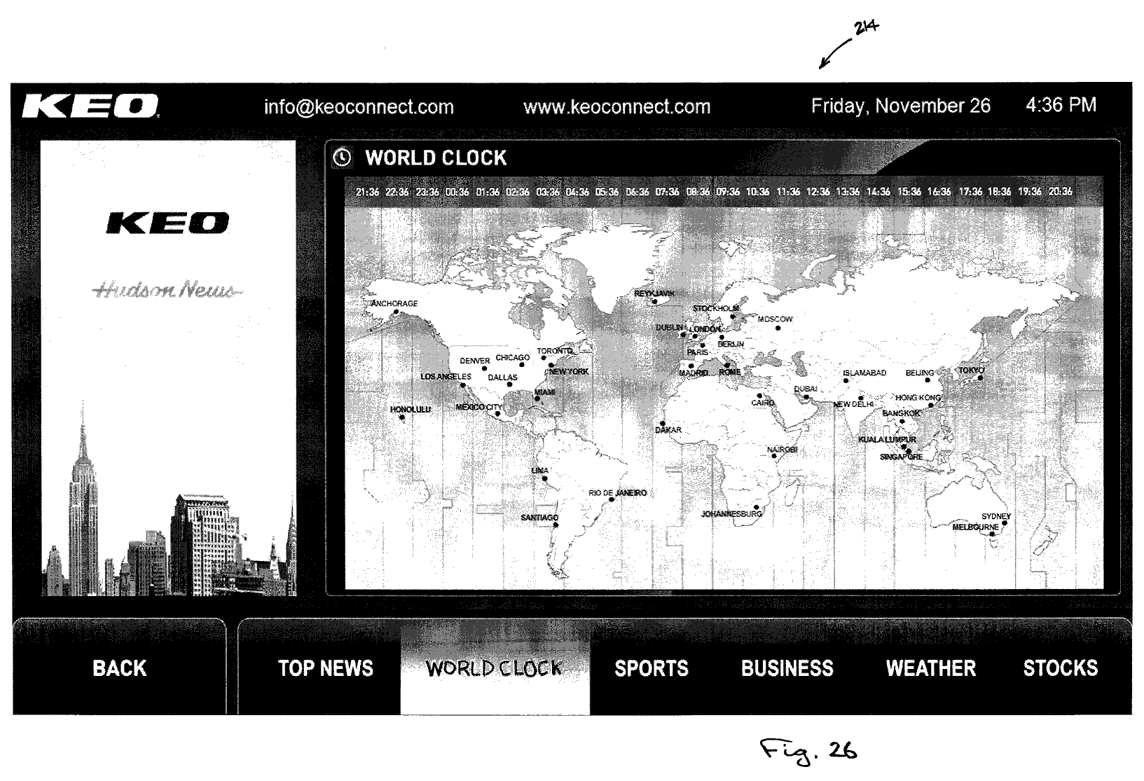

By touching the “WORLD CLOCK” icon, the user will be shown an image like that appearing in FIG. 26. The image is of a world map divided into twenty-four time zones. The user may touch the image at a particular point to find the time at a location within the particular time zone.

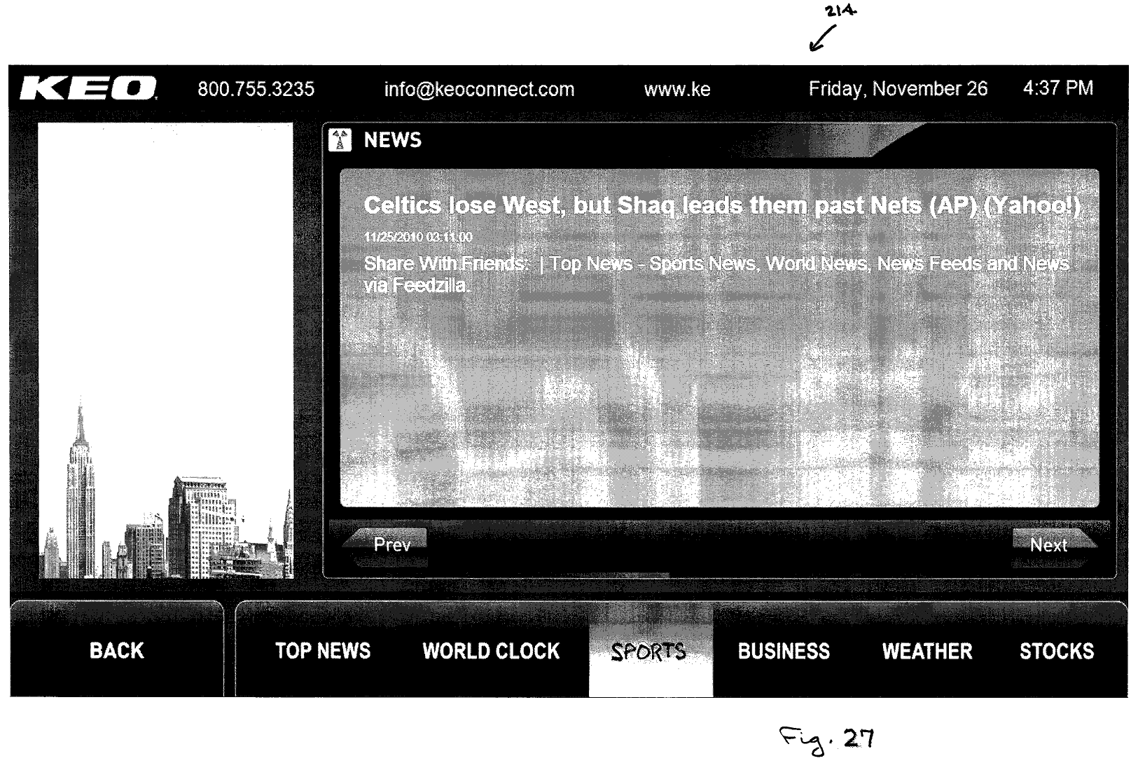

By touching the “SPORTS” icon, the user will be shown an image like that appearing in FIG. 27. By touching the “Prev” and “Next” icons, the user will be able to scroll through the most current sports stories, which are also obtained by means of an RSS feed and updated at two-minute intervals.

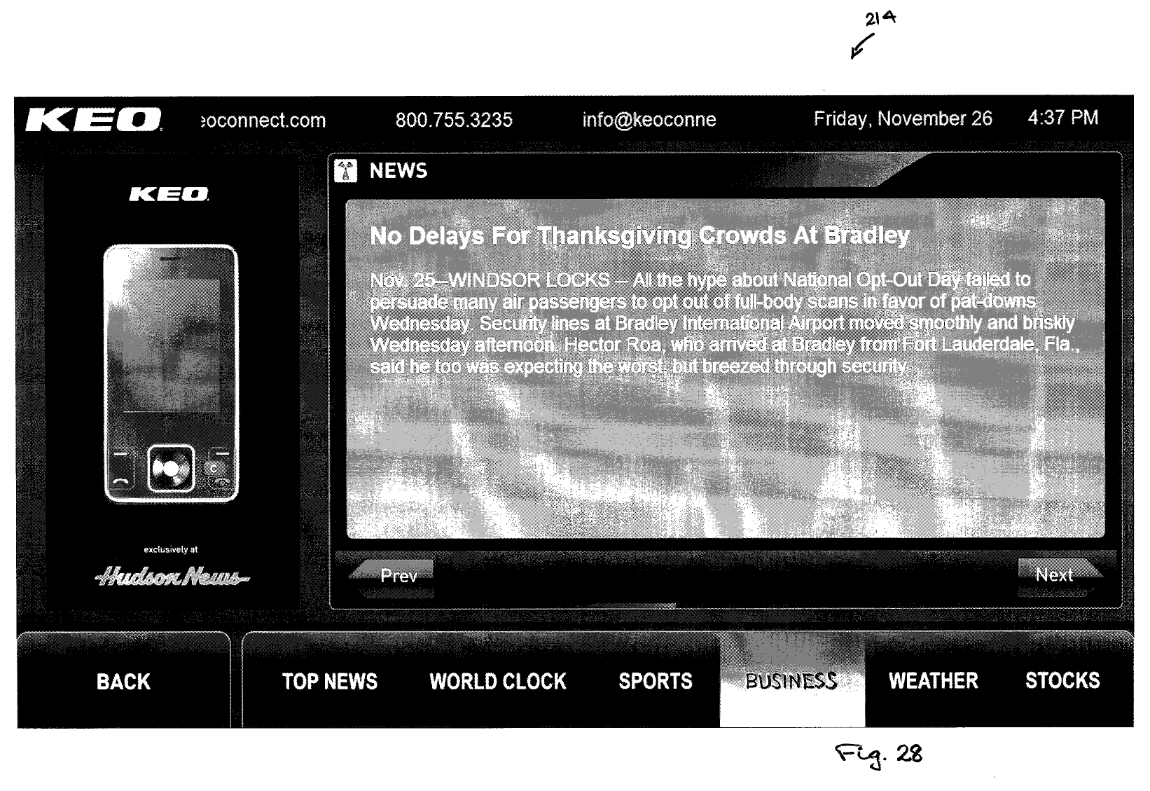

By touching the “BUSINESS” icon, the user will be shown an image like that appearing in FIG. 28. Again, by touching the “Prev” and “Next” icons, the user will be able to scroll through the most current business stories, which are also obtained by means of an RSS feed and updated at two-minute intervals.

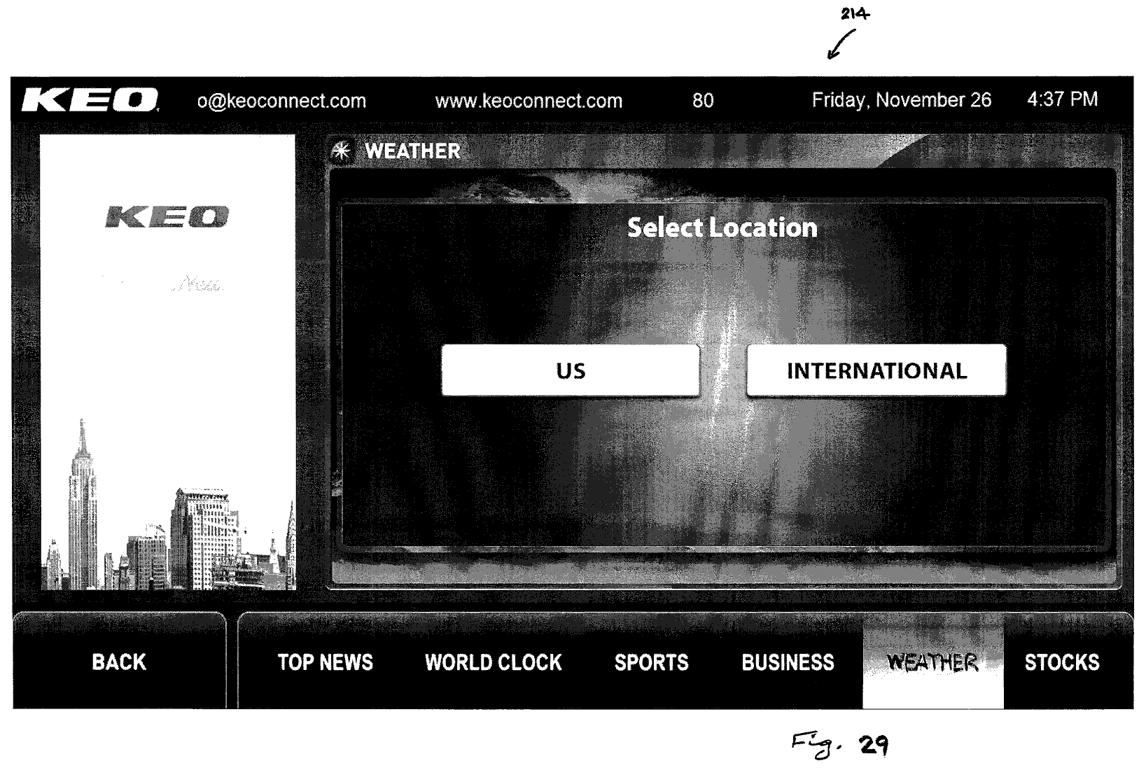

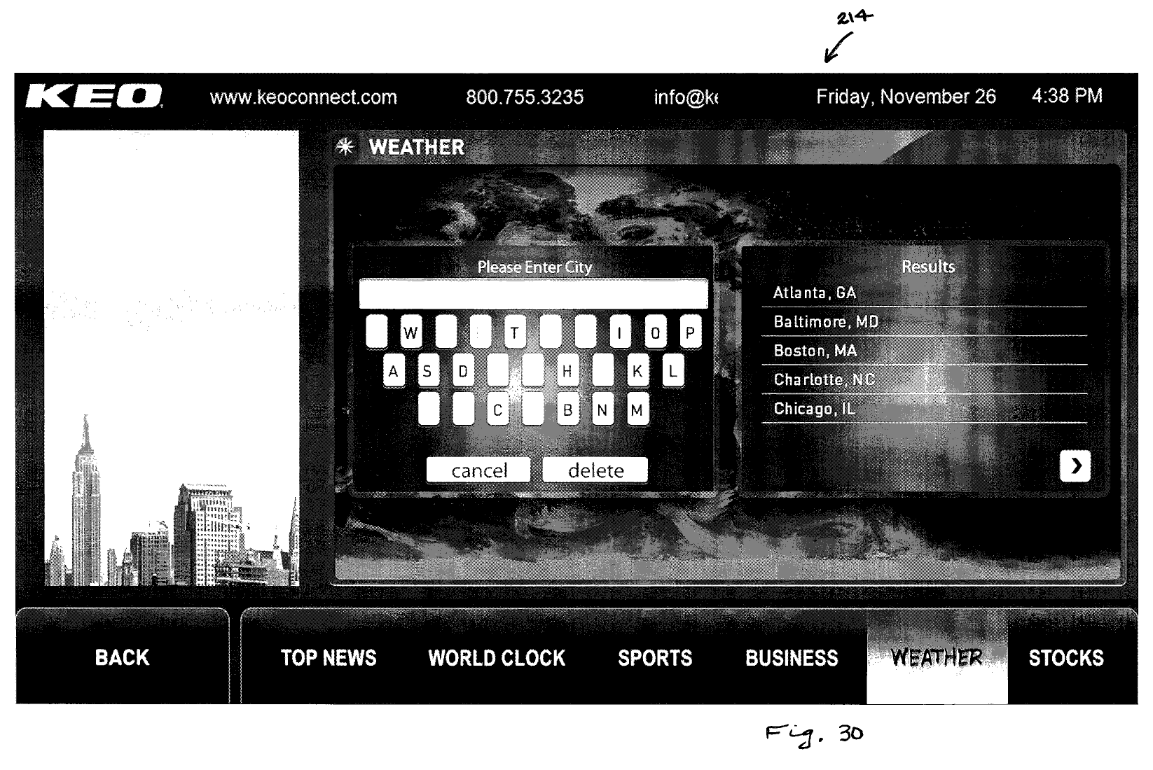

By touching the “WEATHER” icon, the user will be shown an image like that appearing in FIG. 29. The user can obtain a five-day weather forecast for a U.S. or foreign city by touching the appropriate icon. Assuming that the “US” icon was touched, an image like that in FIG. 30 appears on the touch screen 214. The user then enters the name of the city using the touch-screen keyboard, and, if the city is among those available, a five-day forecast will appear on the touch screen 214. When the “INTERNATIONAL” icon in FIG. 29 is touched, an image similar to that in FIG. 30 appears to permit the user to enter the name of a city outside of the United States in a similar manner.

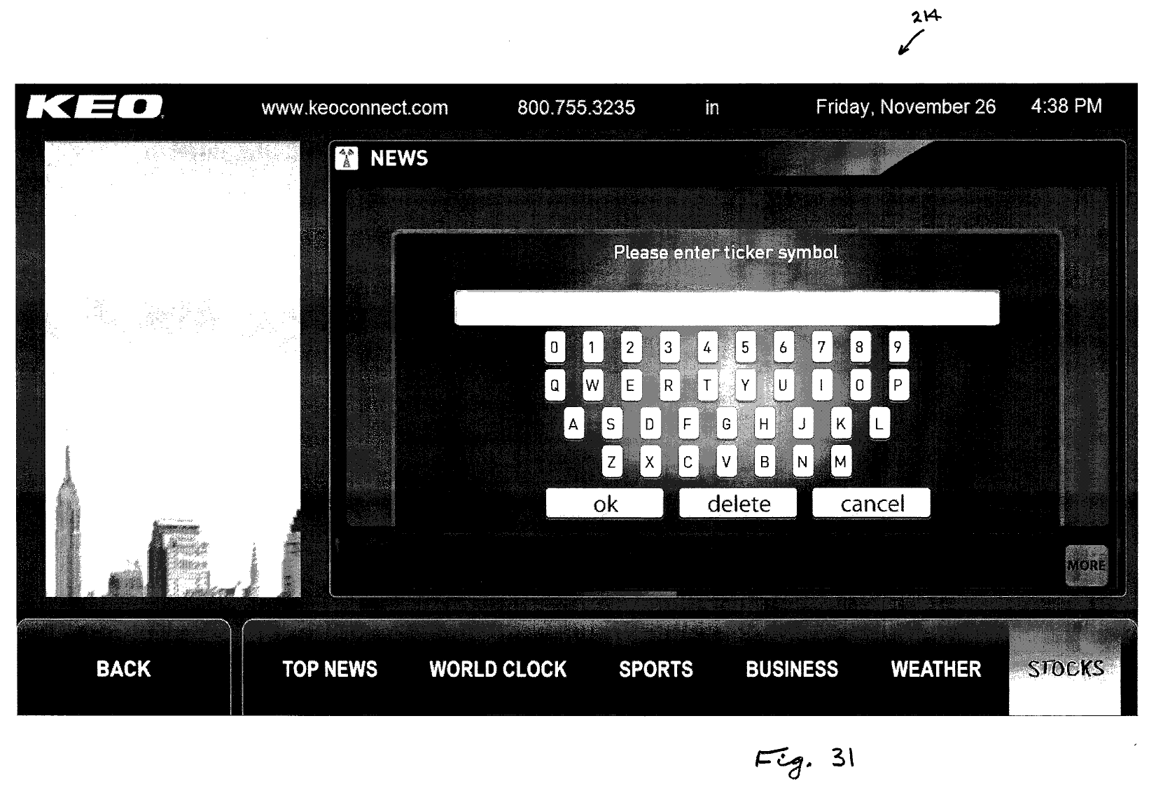

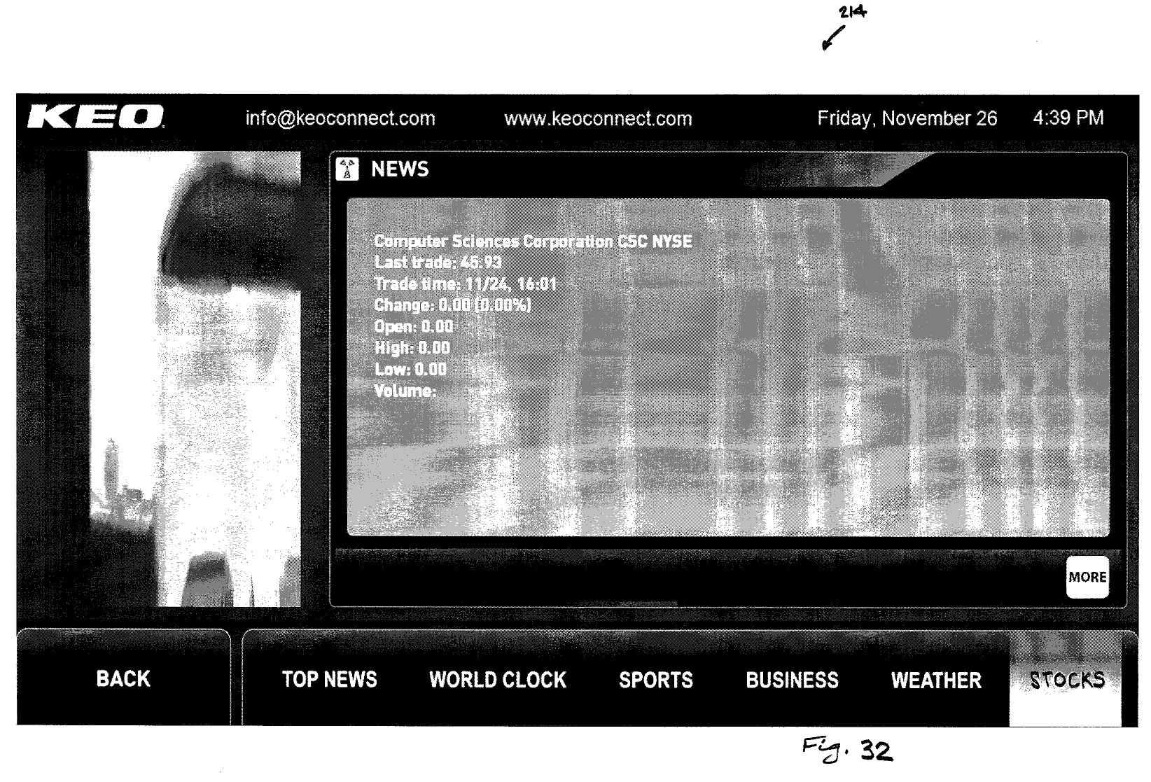

Finally, by touching the “STOCKS” icon, the image in FIG. 31 appears on the touch screen 214. When the user enters a ticker symbol, an image like that shown in FIG. 32 appears to provide the latest data on the stock in question. By touching the “MORE” icon in FIG. 32, the user will be returned to the image shown in FIG. 31 and enabled to enter another ticker symbol.

As stated above, the user may touch the “BACK” icon at any time to exit from the news function and return to the image shown in FIG. 5. If it should happen that the user needs help, he or she may touch the help icon 238 shown in FIG. 5 and in subsequent figures. Help might be required, for example, if a user cannot retrieve his or her cell phone because it is locked in a charging compartment 216, and the user has forgotten the four-digit secret code previously chosen.

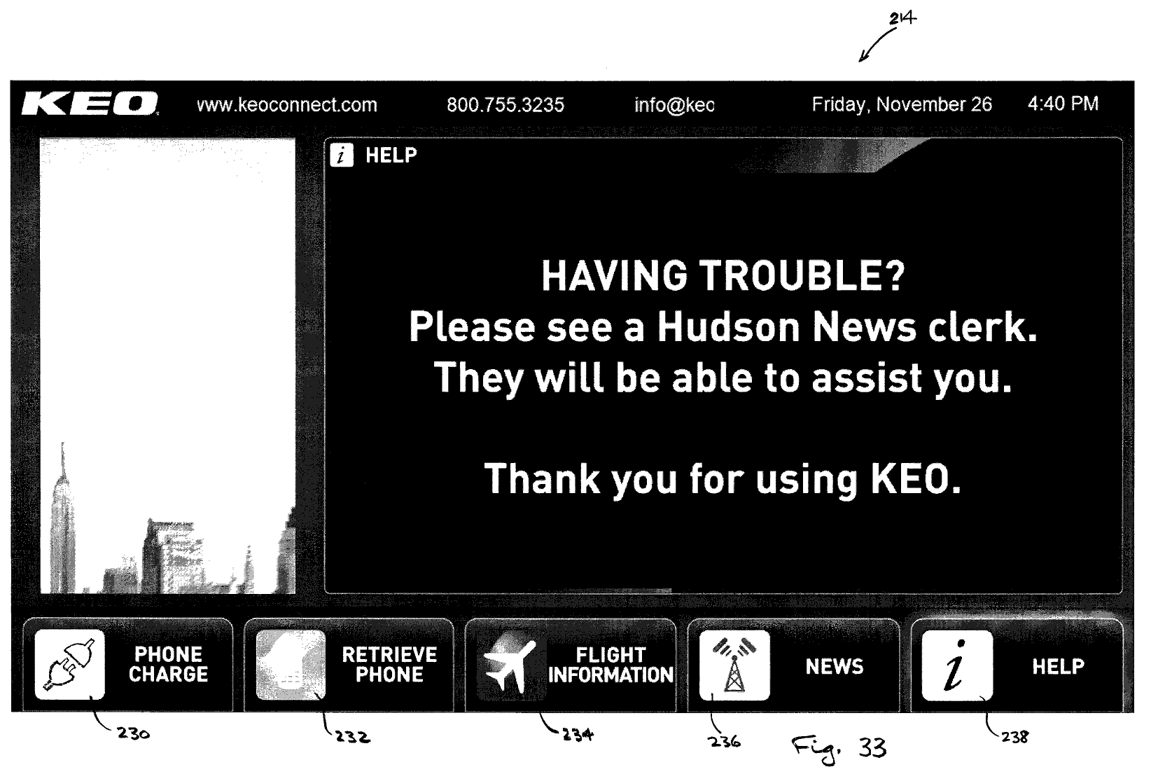

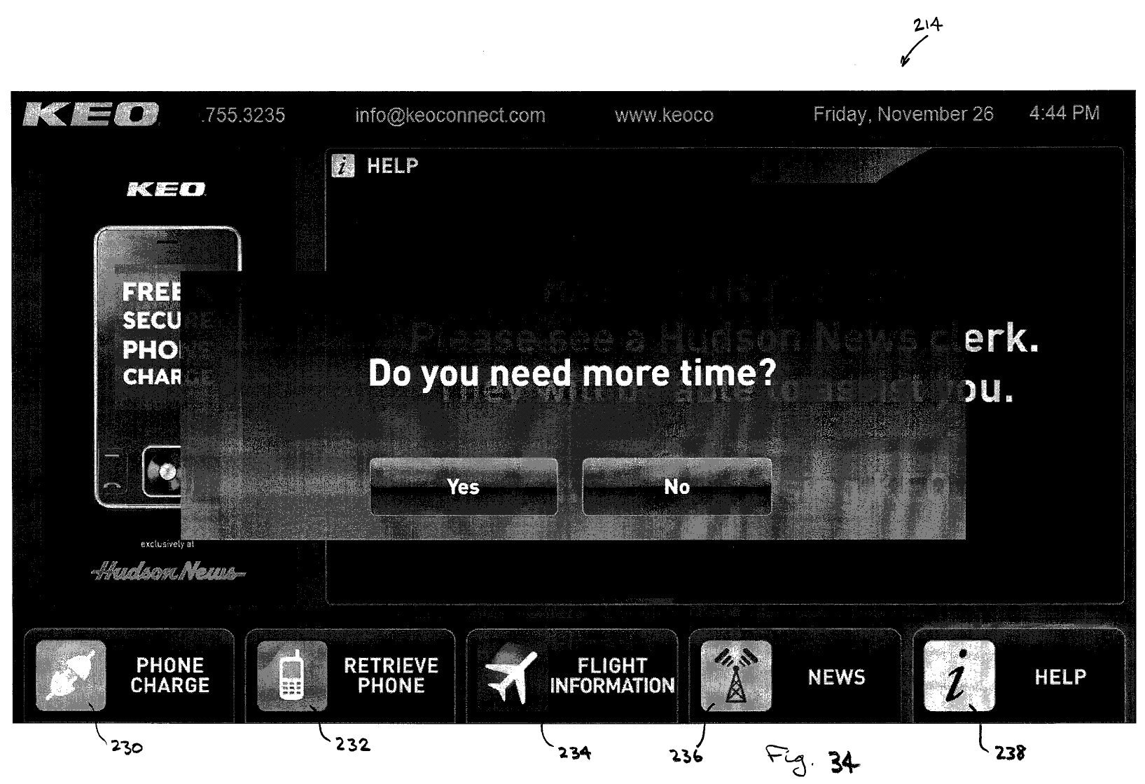

When the help icon 238 is touched, the image shown in FIG. 33 is displayed on the touch screen 214 to direct the user to a clerk at the location of the kiosk 210. After several minutes have passed, the image shown in FIG. 34 appears. If the “Yes” icon is touched, several more minutes will be obtained. If the “No” icon is touched, or if neither icon is touched, the touch screen 214 will return to the image shown in FIG. 5.

Additional functions may be included in the kiosk 210 either with or instead of those discussed so far, depending on the location of the kiosk 210. For example, a currency converter function, with a specific icon on the touch screen 214 may be included for the convenience of travelers in airports. If the kiosk 210 is located in a train station, rather than in an airport, particularly in Europe where travel by train in more widespread than in the United States, train schedules with arrivals and departures and relevant track numbers may be provided in a manner similar to the flight information discussed above.

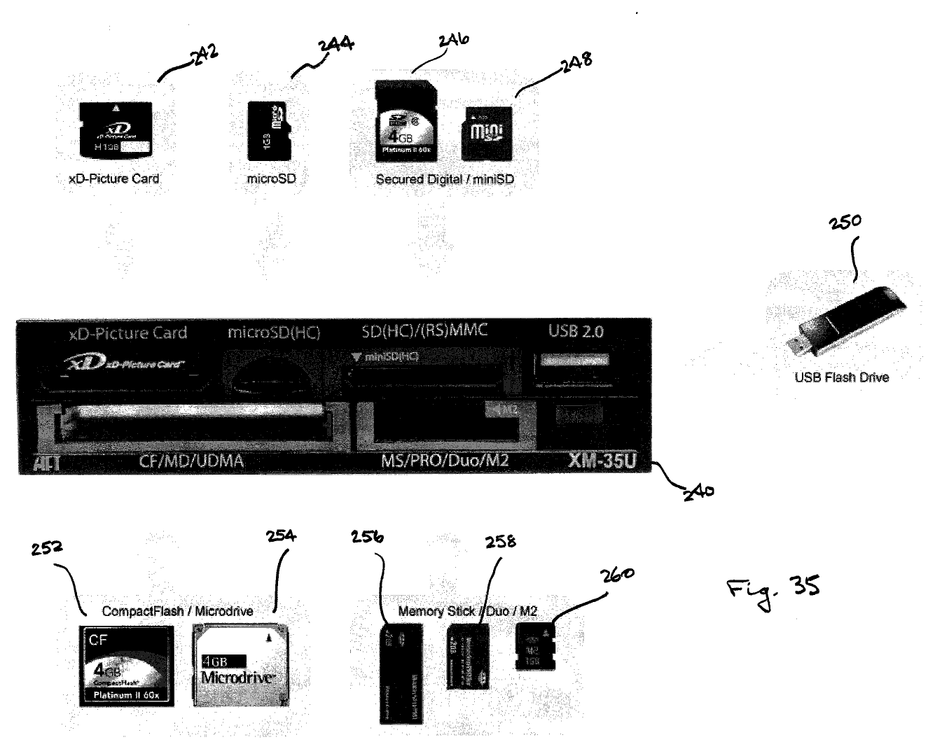

Media downloads are another function that may be included on the kiosk 210. To this end, a media card reader/writer 226 has been included in the kiosk 210. Media card reader/writer 226 may, for example, be an XM-35U media card reader which is available from Atech Flash Technology, Inc. of Fremont, Calif. As shown in FIG. 35, media card reader 240 is designed to download content onto several types of memory devices, namely, the xD-picture card 242, the micro SD 244, the SD digital card 246, the mini SD 248, the USB flash drive 250, the compact flash drive 252, the microdrive 254, the memory stick 256, the duo 258, and the M2 260. The kiosk 210 may be equipped to dispense these devices for users with appropriate payment. In addition, where media download capability is included in the kiosk 210, one of the four charging drawers 216 may also be devoted to media downloads, instead of cell phone charging. In that event, the seven charging adapters “A” through “G” previously described would be replaced by three connectors, namely, a mini connector, a micro connector, and a thirty-pin dock connector, the latter of which is used by Apple devices. Other suitable connectors can be added to fit the demand. Content, including movies and other video, music, books, magazines, newspapers, may be provided by one or more media vendors.

The content, of course, is generally available for purchase. In order to make the necessary payment for this and other functions of the kiosk 210, the magnetic card reader 224 is provided for payment by credit and debit cards.

As noted earlier, the kiosks 100 of the present invention may be situated in a wide variety of locations other than newsstands in airports. For example, the kiosks may be dispersed in car rental sites, where they might provide those renting cars with information on local places of interest and with directions.

Universities are also suitable locations. There, information and advertising targeted to the student population may be used to attract students to the kiosks 100, which may be used to offer debit cards to the students. Pharmacies are another example; there, the advertisements would optimally relate to items actually being sold at the pharmacy, and may include directions to the aisle in the store where the item is displayed for sale. In a pharmacy setting, it would also be appropriate that the kiosk 100 have a health information function, enabling the user to obtain health-related information, such as from an Internet site like WebMD, which might ultimately direct the user to specific products sold in the pharmacy. Kiosks 100 located in stadiums might be provided with seating charts and information on future events, so that a user may purchase tickets for those events using the kiosk 100. Kiosks 100 may also be provided temporarily, on a truck or other suitable vehicle, for use at a special event, such as the Super Bowl, U.S. Open, or a political convention. It should be understood that the functions shown on the touch screen 214 would be tailored to the specific location of the kiosk 100, and would not necessarily be identical to the functions at other locations. In short, the kiosk 100 is customizable for use at a given location. A single Kiosk 100 can also be formed with multiple separate faces with their own screens and interface for multiple concurrent users.

The system 140 is also able to send e-mail messages to users to convey information of interest, such as information about ultimate travel destinations, or the best restaurants at a current location; this kind of information can be sent directly to the user's portable electronic device.

The data mining aspects of the present invention include e-mail address recognition; a user loyalty club, like a “Frequent Flier Club”, and other revenue models as well, such as CPM, cost per click, cost per lead, cost per activation, and so forth.

The e-mail capability of the kiosk system will also tie in with social networking and with onsite activation and engagement. The kiosk system's unique positioning and touch-screen capability will allow users to interact with the advertisement shown on the display 108,212, the content, the applications and the offers. All this can be done while the user is getting a free phone charge.

The kiosk and the website will utilize social networking tactics. The user will “check-in” at each KEO kiosk, and then can “like” KEOCONNECT and KEO on Facebook, Twitter, MySpace, and other similar sites.

The kiosk system will offer customers the ability to purchase movies, books, magazines, newspapers, videos, songs, periodicals, and other digital content. Anything available in hard copy will be available digitally, instantly if it is resident and local in the machine and not a download over the Internet. Rather, in such a case, it will be a transfer, to the customer's media stick, memory cards or directly into their device.

The touch screen 214 tracks every touch point touched on the touch screen and every advertisement that plays on the display 212, so that the operators of the kiosk system will know how many people charged their phones, how many checked their flight, weather, and so forth up to the second.

The kiosk system will host all of the data it collects in its own database at a central control computer or server 140 located off-site for data-mining purposes.

It will thus be seen that the objects set forth above, among those made apparent in the preceding description, are efficiently obtained, and, since certain changes may be made in the above construction without departing from the spirit and scope of the invention, it is intended that all matter contained in the above description or shown in the accompanying drawings shall be interpreted as illustrative, and not in a limiting sense.

It is also understood that the following claims are intended to cover all of the generic and specific features of the invention herein described and all statements of the scope of the invention, which, as a matter of language, might be said to fall therebetween.

What is claimed is:

1. A kiosk comprising:
a first display;
a second display;
interactive means for allowing a user to interact with the kiosk and select content for display on the second display;
computing means operatively coupled to the first display, second display and interactive means for storing content for display on the first and second displays and responding to user input on the interactive means;
connection means, operatively coupled to the computing means, for interacting with a user's portable device;
an enclosure for housing the first display, the second display, the interactive means, the computing means and the connection means;
advertising content stored on the computing means for display on the first display; and
interactive content stored on the computing means for display on the second display.

2. The kiosk of claim 1 further including charging means, operatively coupled to the computing means for charging a user's portable device.

3. The kiosk of claim 2 wherein the charging means includes coupling means for forming an electrical and data connection between the kiosk and the user's portable device.

4. The kiosk of claim 1 further including coupling means, operatively connected to the computing means, adapted to create a data connection with the user's portable device.

5. The kiosk of claim 4 wherein the user can download selected content from the kiosk to the user's portable device when the user's portable device has a data connection with the kiosk.

6. The kiosk of claim 1 wherein the interactive content includes data stored on the computing means and data accessed by the kiosk through the internet.

7. The kiosk of claim 6 wherein the data accessed by the kiosk through the internet is located on a central server dedicated to providing interactive content and advertising to one or more kiosks.

8. The kiosk of claim 1 wherein some of the interactive content is location-specific content relevant to users at the kiosk's physical location.

9. The kiosk of claim 5 wherein the downloadable selected content includes various media content including movies, songs and books.

10. The kiosk of claim 1 wherein the first display is designed to show a loop of advertising content controlled by the computing means.

11. The kiosk of claim 10 wherein the advertising content is adapted to fill the first display with one or more separate images or videos at the same time.

12. The kiosk of claim 1 wherein the second display is a touch screen and the touch screen acts as the interactive means.

13. The kiosk of claim 1 where the computing means includes at least one computer which includes storage media designed to hold the advertising content.

14. The kiosk of claim 1 where the computing means includes at least one computer which includes storage media designed to hold at least some of the interactive content and internet connectivity which provides access to additional interactive content.

15. The kiosk of claim 1 wherein the computing means includes a first computer with storage media designed to hold the advertising content and a second computer which includes storage media designed to hold at least some of the interactive content and internet connectivity which provides access to additional interactive content.

16. The kiosk of claim 1 further including scanning means, coupled to the computing means, for scanning text or images from the user or the user's portable device.

17. The kiosk of claim 1 further including printing means, coupled to the computing means for providing a printed document to the user.

18. The kiosk of claim 2 wherein the kiosk includes one or more charging bays for receiving users' portable devices for charging and/or transferring interactive content to the users' portable devices.

19. The kiosk of claim 1 wherein the advertising content displayed on the first display is changed by the computing means in response to user interactions with the kiosk.

20. The kiosk of claim 1 wherein the connection means includes a wired connection to the user's portable device.

21. The kiosk of claim 1 wherein the connection means includes a WiFi connection to the user's portable device.

22. The kiosk of claim 1 wherein the connection means includes a Bluetooth connection the user's portable device.

23. The kiosk of claim 1 further including location connection means, coupled to the computing means, for communicating with one or more computers or registers near the kiosk's physical location.

24. The kiosk of claim 23 wherein the location connection means transfers transaction data to the computers or registers near the kiosk's physical location.

25. The kiosk of claim 1 wherein the computing means stores a record of the interactions with users and data provided by the users in the course of their interactions with the kiosk.

26. The kiosk of claim 1 wherein the kiosk is placed in an airport and includes interactive content related to flight schedules, weather, news, and other content of interest to an airport traveler.

27. The kiosk of claim 1 wherein the connection means allows multiple users to connect to the kiosk at the same time either on the kiosk or directly through their portable devices.

28. The kiosk of claim 1 wherein the first display means includes more than one display for advertising.

29. The kiosk of claim 1 wherein the second display means and interactive means include provisions for interacting with more than one user at a time on the kiosk.

30. A kiosk network comprising:
a central server;
a plurality of kiosks, operatively connected to the central server to provide two way data flow between the central server and a kiosk and between a kiosk and the central server;
each kiosk including:
a first display;
a second display;
interactive means for allowing a user to interact with the kiosk and select content for display on the second display;
computing means operatively coupled to the first display, second display and interactive means for storing content for display on the first and second displays and responding to user input on the interactive means;
connection means, operatively coupled to the computing means for interacting with a user's portable device;
an enclosure, for enclosing or supporting the first display, the second display, the interactive means, the computing means and the connection means;
advertising content stored on the computing means for display on the first display; and
interactive content stored on the computing means for display on the second display.

31. The kiosk network of claim 30 wherein said central server communicates with each of said plurality of kiosks to modify said advertising content on said computing means with regard to the locations of individual kiosks or the time of day.

32. The kiosk network of claim 30 wherein said central server communicates with each of said plurality of kiosks to track the usage thereof by receiving records of the interactions with users and data provided by the users in the course of their interactions with the kiosks.

33. The kiosk network of claim 32 wherein said central server maintains data on individual users to enable targeted advertisements to be made to said individual users.

34. The kiosk network of claim 30 wherein said central server communicates with each of said plurality of kiosks to modify downloadable media content stored on said computing means in each of said kiosks.
